(19) United States
(12) Patent Application Publication
(10) Pub. No.: US 2002/0062342 A1
(43) Pub. Date: May 23, 2002

(54) Method and system for completing forms on wide area networks such as the internet

(76) Inventor: Charles S. Sidles, Lake Forest, IL (US)

Correspondence Address: Paul E. Schaafsma, FOLEY & LARDNER, One IBM Plaza, 330 North Wabash Avenue, Suite 3300, Chicago, IL, 60611-3608, US

(21) Appl. No.: 09/978,563

(22) Filed: Oct. 16, 2001

Related U.S. Application Data
(60) Provisional application No. 60/252,644, filed on Nov. 22, 2000.

(51) Int. Cl. G06F 15/16

(52) U.S. Cl. 709/203; 709/246; 707/507; 707/513

(57) ABSTRACT

A system automatically intercepts and responds to most requests for personal information that are received from a network and directed to a user. Such requests are intercepted, and the sources of the requests, as well as the user, are validated. The system attempts to complete each request, using information obtained from a wallet database where information is kept secure and is associated with non-personal identifiers. The system attempts to complete requests by searching a dictionary database for request-type-specific rules that indicate, by non-personal identifiers, what personal information is to be entered into which fields of each request or form. The system may also attempt to complete requests or forms using rules for other types of requests that are applied to a new type of request using the principles of fuzzy logic or artificial intelligence. The system also includes a history database where previously user-validated requests are kept with personal information replaced with non-personal field identifiers, and it may attempt to complete requests by reference to requests in this history database. After a form is completed either by the system with user validation, or by the user, it may be kept in the history database, and new rules may be derived either through the use of fuzzy logic or artificial intelligence or study of the requests in the history database. These new rules may be added to the dictionary database. The fuzzy logic or artificial intelligence system may also be given positive or negative feedback.

### CROSS-REFERENCE TO RELATED APPLICATIONS

This application claims priority to U.S. provisional patent application Serial No. 60/252,644, filed on Nov. 22, 2000, which is hereby incorporated by reference into this specification.

### BACKGROUND OF THE INVENTION

1. Field of the Invention

The present invention relates generally to methods for automatically complying with requests for information received from a wide area network, such as the Internet. More specifically, the invention relates to a method and system for completing the blanks in a form document received from Internet web sites for purposes such as the submission of personal and billing information in conjunction with a purchase or registration made over the Internet.

2. Brief Description of the Prior Art

The Internet is now well established as a marketplace where people may shop and make purchases using credit cards and other types of identification information. While most of today's users of the Internet believe it is a recent communications phenomenon, the origins of the Internet actually go back several decades. Today's Internet grew out of a computer resource-sharing network created in the 1960s by the Advanced Research Projects Agency (ARPA). This computer resource-sharing network, which came to be known as the ARPAnet, was primarily designed by ARPA's chief scientist, Larry Roberts. The initial problem facing a wide-area computer resource-sharing network was how to efficiently transmit digitized information in a reliable way. To solve this problem, in 1968, Roberts mandated use of a packet-switching design in the ARPAnet.

Packet switching breaks up blocks of digitized information into smaller pieces called packets. These packets are transmitted through the network, usually by different routes, and are then reassembled at their destination. Eight years prior to ARPA's design, Len Kleinrock invented packet switching. See, e.g., Len Kleinrock, “Information Flow in Large Communications Nets,” RLE Quarterly Progress Report (1960); Len Kleinrock, Communication Nets (1964). See also Paul Baren, “On Distributed Communications Networks,” IEEE Transactions on Systems (March 1964). Roberts believed that packet switching was the means to efficiently transmit digitized information in a reliable way.

The next problem to solve was how to interconnect a number of mainframe computers, most of which utilized different languages and different operating systems. Wesley Clark of Washington University in St. Louis, Mo., devised the solution to this huge incompatibility problem. Clark proposed that a smaller minicomputer should interface between every mainframe and the network. All of these minicomputers would run on the same operating system and use the same language. Each mainframe, therefore, would only be required to interface with its own minicomputer, with the minicomputer translating into the network operating system and language. These Interface Message Processors (IMP), which provided an interface between the ARPAnet host mainframe computers and the ARPAnet, were the predecessors to today's routers. With this basic design, the first two nodes on the ARPAnet communicated on Oct. 1, 1969.

By 1971, fifteen nodes, mostly academic institutions, were up on the ARPAnet. However, the original goal of the ARPAnet was not being realized. Resource sharing of the mainframe computers was simply too cumbersome. In March 1972, however, Ray Tomlinson of Bolt, Beranek & Newman invented e-mail. Use of this message transfer program quickly grew to be the initial major use of the ARPAnet.

By the mid-seventies, the ARPAnet was not the only network utilizing switching packets. Once again, an incompatibility problem emerged. Each of these different networks used a different protocol. Thus, interconnection of these different networks was not possible. The solution, devised by Robert Kahn of ARPA and Vincent Cerf of Stanford University, was called the Transmission Control Protocol/Internet Protocol (TCP/IP). The Transmission Control Protocol (TCP) packetized information and reassembled the information upon arrival. The Internet Protocol (IP) routed packets by encasing the packets between networks. See, e.g., Robert Kahn and Vincent Cerf, “A Protocol for Packet Network Intercommunication,” IEEE Transactions on Communications Technology (May 1974). Transmission Control Protocol/Internet Protocol was adopted by the ARPAnet in 1983. With the addition of the Domain Name System (DNS) in November 1983, the now familiar Internet address protocol was established.

A final step in creating the Internet occurred in 1990, when an Englishman, Tim Berners-Lee of the European Center for Particle Research (CERN) in Switzerland, invented the World Wide Web. This paradigm, based on a program Berners-Lee had written in 1980 to allow users to store information using random associations, allowed material from any computer, from any format to be translated into a common language of words, images and addresses. Berners-Lee's program established the three core components of the World Wide Web: the Universal Resource Locator (URL), HyperText Markup language (HTML), and Hyper Text Transfer Protocol (HTTP).

Uniform Resource Locators (URLs) are used to identify specific web sites and web pages on the Internet. URLs also identify the address of the document to be retrieved from a network server. HyperText Markup Language (HTML) is a commonly used scripting or programming language that permits content providers or developers to place hyperlinks within web pages. These hyperlinks link related content or data, which may be found on multiple Internet host computers. HTML document links may retrieve remote data by use of Hyertext Transfer Protocol (HTTP). Alternatively, File Transfer Protocol (FTP), Gopher, or other Internet application protocols can be used. When a user clicks on a link in a web document, the link icon in the document contains the URL that the client employs to initiate the session with the server storing the linked document. HTTP is the protocol used to support the information transfer.

Typically, when someone decides to make a purchase over the Internet, the web site of the vendor submits to the user an HTML document that asks for the user to submit such things as name, address, telephone number, and credit card information; and that includes blanks into which the user may type this information. In the case of users making purchases using telephones or hand held personal assistants through a wireless gateway, similar forms are used but follow the Wireless Mark-up Language (WML) document mark-up file format (or alternative mark-up languages for handhelds/wireless such as cHTML or HDML). These forms take time for the user to fill out, and they are frequently rejected due to errors in typing. In particular, the WML forms, which must be completed by typing or writing into a very small window on a telephone or personal digital assistant (PDA), can be quite difficult for a user to fill in.

A number of attempts have been made to speed up this process. Microsoft has worked with a number of vendors to develop a wallet system that is now part of its Windows 98 operating system when used in conjunction with Microsoft's web browser. The Microsoft Passport system allows users to store personal information on a central server that can then be used at a limited number of pre-selected merchant sites on the internet. The main disadvantage of Passport is that is does not provide any services to the customer when they access a merchant site that is not linked to the passport system, so the user is severely limited in the number of places they can use the service. This is especially true for users outside the U.S.

Other devices for facilitating the submission of credit card and personal information include the so called “one click” systems present on the web sites of some vendors. These systems encourage users to submit their credit card and personal information in advance, to be held by the vendor or by a consortium of vendors. Then, when an individual wishes to make a purchase, they provide a user name and/or password to authenticate themselves to the vendor and then click with a mouse button or touch with a pen stroke, and the purchase is completed using the payment details stored with the vendor. However, these systems suffer the considerable disadvantage that the individual loses control over his or her personal information, as well as credit information, by having it stored on each individual vendor's database. This system also requires the user to remember a large number of different user name and password types and combinations, as most merchants have their own specific authentication methodology.

Another existing system for facilitating a similar type of process is . . . “gator.com” which takes a decentralized approach to automatic form filling. Basically, its users download a Windows utility that integrates with Microsoft's Internet Explorer. The main deficiency is that there is no security in place. Since all data is stored locally, anyone with access to that specific Windows computer can obtain specific secure information (Windows 9x is basically insecure during log-on). An additional weakness is that the system is not capable of making intelligent guesses regarding information that can be filled in on a form. The user is obligated to type in all the information, rather than letting the system input existing database information to speed up access to a new site based upon existing information. Every user who goes to a new site must complete all the fields even if many users prior to that have completed the same form and accessed the same database.

Accordingly, what would be desirable is the achievement of an automatic method for filling out forms in a way that preserves the privacy of the individual user by keeping personal information, credit card information, and the like safe and under the control of the user or the user's service provider. This automatic method for filling out forms also should greatly speed up such purchasing transactions. This automatic method for filling out forms should enable users to fill in data forms quickly and efficiently on commercial sites all over the Internet. This automatic method for filling out forms should eliminate the necessity of manually establishing a directory of merchant forms. This automatic method for filling out forms should be able to fill out forms from both known sites and completely new sites.

### SUMMARY OF THE INVENTION

The present invention provides an automatic method for filling out forms in a way that preserves the privacy of the individual user by keeping personal information, credit card information, and the like safe and under the control of the user or the user's trusted service provider. It provides an automatic method for filling out forms that greatly speeds up purchasing transactions. It also enables users to fill in data forms quickly and efficiently on commercial sites all over the Internet. The present invention eliminates the necessity of manually establishing a directory of merchant forms. It also can fill forms from both known sites and completely new sites. It is self learning, and it improves performance on future occasions based upon historic results.

The present invention contemplates auto detection of vendor forms requesting such information, by the fact that they are marked as secure forms which are to be handled in an encrypted manner, and/or by the fact that they are “fill in the blank” type forms that are requesting information. These forms are diverted to a special system which, after authenticating the user and validating the web sites from which the forms come, obtains the user's personal and payment information from a secure site and attempts to fill out the form by the application of rules that indicate what user information goes into which blanks in the forms. If this effort is successful, an abbreviated version of the form is sent to the user for approval. Once the information is approved, then the completed form is submitted to the vendor's web site for processing. However, if the information required to complete the form is not identifiable based on pre-existing rules for that site, then an artificial intelligence system attempts to fill out the form using a set of known rules modified by the principles of fuzzy logic or artificial intelligence. If this also fails, then a history database is checked to see if the same form has been encountered and filled out previously. If so, the form is filled out with user information using the previously entered information as a guide. If the form is not found within the history database, then the incomplete sections of the form are presented to the user for manual completion.

After the user reviews and optionally revises the information in the form, the form is analyzed by the system. The information that the user filled in is saved in the history database to be used as a guide for automatic completion of this same form in the future. If the form was filled out using information in the history database as a guide, then rules for filling out that form are derived from matches in the two sets of user-entered information that have been gathered and are saved for future use, and the relevant sections of the form are then deleted from the history database. If artificial intelligence was used to complete the form, then any artificial intelligence rules that were developed by the fuzzy logic or artificial intelligence system and that gave correct results are saved for later use in completing the same form and other forms. The fuzzy logic or artificial intelligence system is also advised of its performance so that it can make adjustments and improve its future performance.

The user's personal information and credit card information are maintained in a secure server under the control of the user's service provider and are not made available to vendor and other web sites except when a transaction is carried out and after the user authorizes the release of the information. Access to this personal information is not granted until the user has definitely been verified, either through special cookies placed upon the user's system or by means of an identifying user name and password. In addition, only the forms of vendors whose identity has been validated are filled out and submitted in this automated fashion.

### BRIEF DESCRIPTION OF THE DRAWINGS

FIG. 1 is an overview block diagram of an automated personal information form fill software system in accordance with the principles of the present invention shown used in an Internet environment in conjunction with a personal computer (PC) and a wireless telephone or Personal Digital Assistant (PDA).

FIG. 2 is a program element block diagram and data flow path diagram illustrating the operation of the form fill software system of FIG. 1.

FIG. 3 is a flow diagram of the steps performed by the data flow monitor of FIG. 2.

FIG. 4 is a flow diagram of the steps carried out by the form fill proxy of FIG. 2.

FIG. 5 is a continuation of FIG. 4 showing additional steps carried out by the form fill proxy.

FIG. 6 is a flow diagram of the steps performed by the match engine of FIG. 2.

FIG. 7 is a continuation of FIG. 6 showing additional steps performed by the match engine.

FIG. 8 is the flow diagram illustrating the steps carried out by the completed form analysis engine of FIG. 2.

FIG. 9 is a flow diagram of a program that saves forms in a history database shown in FIG. 2.

FIG. 10 illustrates the data structure of the dictionary database of FIG. 2.

FIG. 11 illustrates the data structure of the wallet database of FIG. 2.

FIG. 12 illustrates the data structure of the history database of FIG. 2.

FIG. 13 is a flow diagram illustrating the steps performed by the form field compare engine of FIG. 2.

### DETAILED DESCRIPTION OF THE PREFERRED EMBODIMENT

Introduction

The present invention, in its preferred embodiment, is an artificial intelligence form fill software system (or program, or set of related programs) 100 that speeds up and simplifies the process of completing on-line forms, including forms from merchants that are necessary when buying goods and services on a wide area network such as the Internet. The invention enables users to fill in data forms quickly and efficiently on commercial sites all over the Internet. The invention eliminates the necessity of manually establishing a directory of merchant forms. By incorporating a rule-based expert system, the invention can complete payment forms from thousands of merchant's sites. The preferred embodiment of the invention, referred to herein as the “form fill software system 100” (also known as the “WIPPIR Technology” system),is different from other form-fill applications because it can fill forms from both known sites and completely new sites, making intelligent guesses about the meaning of each data field based on existing information.

The form fill software system 100 platform is an integrated, end-to-end support for automated form filling. The form fill software system 100 works in a similar way on both wireless and regular Internet because it is independent of the transport layer and the file format.

The first module spiders web sites and brings the HTML/WML files into a central repository. The module then indexes the whole repository and produces an index that measures the relative importance of a site. The relative importance of a site is based upon the number of other sites that refer to that site. For example, if the whole index has 20,000 sites, then a site that is referred to by 4,000 other sites is more important than a site that is referred to by only 250 other sites. If two sites have the same number of references (for example only one for each of them), then the most important site is the one that is referred to by a site with a bigger relative importance, i.e., number of references.

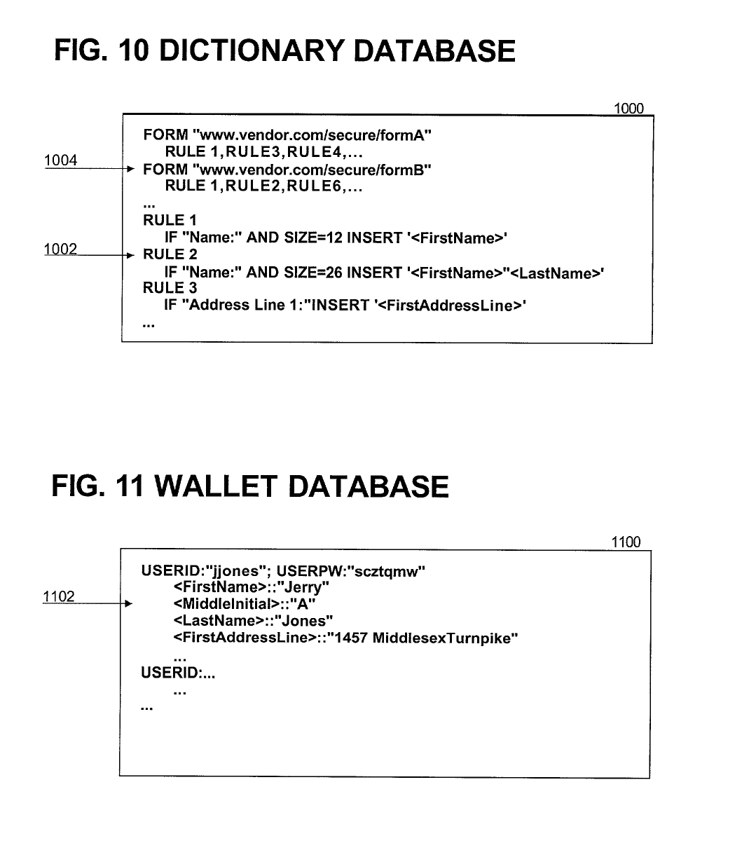

All forms 126, especially forms requesting payment information, are isolated from the general Internet pages. The forms 126 are indexed in a “dictionary” 1000 (FIG. 10) database (alternatively called the WIPPIR dictionary”) for later use in automated form filling. The dictionary 1000 allows the forms 126 to have a default form structure and name while still being able to use derivatives or variants of the default. The dictionary 126 incorporates a series of names associated with certain form components that are then used to populate the merchant payment forms 126. An example would be a list of different terms used when a merchant is looking for a buyer's last name, such as “Last name:” or “Last name”. The dictionary 1000 structure permits the treatment of non-English languages as English variants (as opposed to building the same system as a whole for a foreign language). The benefits of such treatment include faster development, cheaper and more secure maintenance, and faster day-to-day operation.

Data flow monitor 300 software (also called “WIPPIR client” software) will be installed at either the WAP Gateway or HTTP Proxy level (data flow monitor 300a) or at the device operating system (or mobile phone with operating system) level (data flow monitor 300b). Where the software is installed depends upon whether the device (PC 110 or wireless telephone or P.D.A. 106) has an independent operating system 112. It is also possible to have the data flow monitor 200 be an applet that is installed partially on the device 106 or 1 10 and partially on the server that contains the proxy and gateway 116 or 122 or on some other convenient server. The data flow monitor 300 (or client) software intercepts all data flows and scans for forms. When this client software identifies a payment form that needs to be filled in, it transmits the personal information (or user details) to a form fill system (or program) 200 (also called the “WIPPIR Server”) together with the form 126 to be filled. The form fill system 200 then attempts to fill the merchant payment form 126 or authentication information form with the appropriate personal information (or details) that are provided by a wallet database 1100.

The form fill system 200 first tries to fill the form 126 by comparing field names of the form 126 (“NAME,” “CARD,” etc.) with its dictionary 1000 list of field names (“Name:”, etc. in FIG. 10). If the form 126 is not fully completed in this first step, the form fill system 200 tries to guess how to fill the form 126 data fields that remained unfilled from the previous attempt by using a rule-based expert system with fuzzy logic 248. This part of the form fill system 200 is referred to as the expert system (or “WIPPIR Expert System”). It can be implemented using fuzzy logic or artificial intelligence components that perform in a manner similar to fuzzy logic. Fuzzy logic is a term defining systems able to make decisions in situations where more outcomes are possible, as opposed to the normal yes/no algorithmic logic implemented in most typical systems. Normal systems have a finite number of possible states, described entirely by the initial program. Fuzzy logic systems can make decisions in unpredicted situations, and are capable of learning and improving their algorithms and results. Based on this approach, such systems are widely used in form/speech recognition, expert systems, and all forms of artificial intelligence.

If the dictionary 1000 and the fuzzy logic 248 or other expert system (or “WIPPIR expert”) are unable to complete all entries on the form 126, then the form fill system 200 tries to look into its history database 1200 to see if in the past that specific site 104 and form 126 had been form filled by a human person (not by a machine). If so, then the system 100 can extract the rules 1002 (FIG. 10) for filling in the form 126. If not, the person trying to perform the transaction will eventually have to manually input the data. The data flow monitor 300 intercepts what the user fills in and sends it to the form fill system 200, which will write it to a history database 1200 for future use. Following completion of the form 126, the form is returned to the merchant for processing.

The history system (history unit 230, history database 1200, etc.) is notified to start the search process at the same time as the automatic rule-based system (automatic filler 218, rules engine 220, dictionary 1000, fuzzy logic 248, etc.) is notified to start. The history search is initiated simultaneously because of the size of the history database 1200 relative to the rules dictionary 1000. The size of the history database 1200 means that it will likely take much longer to search for entries there compared to searching for rules in the rules dictionary 1000. However, because the system 100 is designed to be a continuous process, if the history database 1200 returns form information prior to the automatic filler 218 or fuzzy logic 248 components, then the history information is added to the form 126.

System Overview

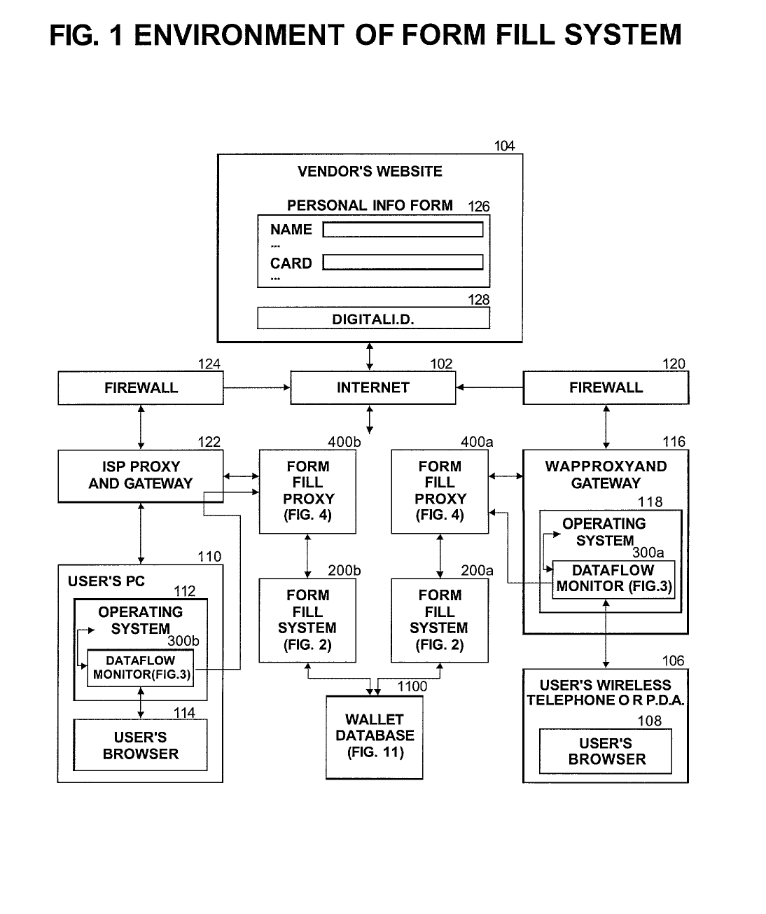

With reference to FIG. 1, an overview block diagram of a preferred form of a secure Internet based form filling system 100 is shown. The system 100 is built to work with the Internet 102 wide area network which interconnects numerous vendor and other web sites. A typical vendor web site 104 is shown in FIG. 1. Individuals wishing to gain access to the Internet and to the vendor's web sites may do so using wireless telephones or PDAs 106 containing a browser 108 built in. In addition, they may gain access using a PC 110 having an operating system 112 such as Microsoft's Windows ME or Apple's OS X and also having a Microsoft Explorer, Netscape Navigator or similar Internet browser 114. The wireless telephone or personal digital assistant 106 may also contain an operating system, in which case its block diagram would appear similar to that of the user's PC 110. However, many wireless telephone accessories contain only programs in read only memory (ROM) and do not have an operating system to which Internet applets can be attached.

The wireless telephone or personal digital assistant 106 may be designed in accordance with the wireless application protocol, or WAP, which is a simplified version of the hypertext transfer protocol, or HTTP, used by the browser 114 within the user's PC 110 to communicate over the Internet.

The WAP wireless telephone or PDA 106 communicates via a wireless link with a WAP proxy and gateway 116 having an operating system 118 and from the gateway 116 through a firewall 120 to the Internet 102. The user's PC 110 communicates over conventional telephone lines, over leased digital telephone lines, over a cable access television (CATV) or other broadband system to an independent service provider (ISP) proxy and gateway 122 and from there through a firewall 124 to the Internet 102. There may also be a radio link between the user's PC 110 and some form of a base station, which may contain a local router, such that the PC 110 may also be wireless and may even be portable.

When a user wishes to make a purchase from a vendor's web site 104, the user of a PC 110 browses through HTML or XML shopping pages reviewing descriptions of products and selecting those products. In the case of a wireless telephone or PDA 106, the user might typically browse through handheld device mark-up language (HDML) or wireless mark-up language (WML) pages in the same manner, using typically simplified, smaller pages. When the user is ready to make a purchase, the user clicks on (or touches with a stylus) a link to a “secure form” 126, asking that this form be displayed on the user's browser 108 or 114, so that the user may fill in the blanks is this form. The form solicits information such as name, address, credit card number, password (PIN, PKI certificate, etc.) and other such personal information that is needed to complete a purchase. There is an important difference between this link, which is a secure link, and an ordinary hypertext link. An ordinary link in a typical web page is prefixed by “HTTP:// . . . ” to indicate that a web page is to be downloaded using the hypertext transfer protocol in the case of the PC 110. However, a secure page has an address that is prefixed with “HTTPS:// . . . ” to indicate that the downloading is to be done in a secure manner from a secure web site, using encryption, public-private keys, and site validation by digital identification.

Modern user's browsers 108 and 114 and modern web sites 104 are designed to include secure socket layer (SSL) technology, which provides for an encrypted and secure two-way communication between a user and a vendor with such sensitive information. Companies such as VeriSign, Incorporated provide this software and also provide computational techniques whereby the integrity and identity of a given vendor's web site may be verified using a server's digital identification (I.D.) 128. The details of all this are well known and need not be explained here in full detail. For communication from the WAP Gateway 116 to the User's Wireless Telephone or PDA 106, the secure transmission is switched from SSL to Wireless Transport Layer Security (WTLS). WTLS performs the same function as SSL but is used for encrypted communication over airwaves from a wireless device to a WAP gateway.

The user's browsers 114 and 108 process this type of link differently than they do a normal link. They initiate a connection with the vendor's web site 104. The server at the vendor's web site responds by sending back its digital I.D. 128 to the browser 108 or 114. Then software in the user's browser 108 or 114 verifies the server's digital I.D. to gain assurance that the name of the web site corresponds to the corporate vendor having that name and is not a fraudulent web site. The user's browser 114 or 108 then sends the vendor's server a session key encrypted using the public key of the vendor.

Once that step is completed, a secure communication dialog can begin between the browser 114 or 108 and the vendor's web site 104. As a first step in this secure communication dialog, the browser 114 or 108 request the downloading of a personal information form 126. This form is displayed to the user, who fills in the blanks, or open fields, in the form and then executes a command that returns all of the supplied information back to the vendor's web site 104 where the purchase transaction is then completed.

The present invention contemplates relieving the user of the necessity of having to manually complete such forms. Accordingly, as a first step towards this goal, the preferred embodiment of the present invention provides a data flow monitor 300a installed within the operating system 118 of the WAP proxy and/or gateway 116 that services the WAP wireless telephone or PDA 106. Likewise, the present invention provides within the operating system 112 of the user's PC 110 a similar data flow monitor 300b. Where there is a wireless device with an operating system (such as a mobile phone or a PDA) the data flow monitor can be installed within the operating system of the wireless device. The data flow monitors 300a and 300b are customized to the characteristics and protocols of the operating systems 112 and 118 within which they are embedded. The data flow monitor may also be partially resident on the device (PC 110 or wireless telephone or P.D.A. 106) and partially on a server, such as the one containing the proxy and gateway 116 and 122 or on some other convenient server.

The reason why the data flow monitor 300a is installed as an “add on” within the proxy and gateway 116 while the data flow monitor 300b is installed as an applet within the operating system 112 of the PC 110 is that many wireless telephones and other accessories do not truly have an operating system that could be modified by means of an applet and, accordingly, it is essential to install the data flow monitor at the proxy and gateway 116. In a hybrid system, a proxy and gateway may have some clients that have an operating system and that may contain a data flow monitor and other clients that have no operating system and no data flow monitor. In this case, a simple priority scheme causes the appropriate data flow monitor to be selected while the other is disabled for a particular client session with the proxy and gateway. And, as mentioned above, the data flow monitor 300 may be resident, in part, on some server.

In either case, the data flow monitor is a simple program installed within the TCP/IP stack that monitors the flow of data packets leaving the browsers 108 and 114 looking for those packets that contain a request for the downloading of a secure page. While there are many ways that such packets could be identified, one way would be, for example, to examine such packets at the TCP level to determine to which socket number in the vendor's web site 104 each packet is addressed. Normal requests for hypertext pages are addressed to socket number 80 within the server, while secure web page download requests are normally addressed to a different socket number.

When the data flow monitor 300a or 300b detects such a secure request for the downloading of a form, it intercepts the request and reroutes it to a form fill proxy 400a or 400b by changing the request's internal IP address from that of the vendor's web site 104 to that of the form fill proxy 400a or 400b. Accordingly, the form fill proxy 400a or 400b ends up receiving the secure access request, which contains the web address of the personal information form 126 on the vendor's web site 104.

After verifying the authenticity of the vendor's web site as well as the identity of the user, the form fill proxy 400a or 400b downloads the personal information form 126 from the vendor's web site 104 and passes it to the form fill system 200a or 200b to be filled out using personal information that is retrieved from a wallet database 1100, as will be explained below. The completed form is then returned to the form fill proxy 400a or 400b which normally causes the form to be displayed upon the user's browser 108 or 114 so that the user may review and correct the information in the completed form. The form is then returned to the form fill proxy 400a or 400b at the same time that it is submitted to the vendor's web site 104. The system operates to intercept the form going in both directions, coming from the merchant to the customer and coming back from the customer to the merchant. However, in cases where the form is well-known and the rules for completing the form automatically are settled and established, user feedback may not be necessary, and the step of displaying the completed form upon the user's browser 108 or 114 may be skipped. This can be made a user option with frequently-encountered forms. For example, when presented with a form for verification, the user may be given the option of requesting that a particular form, in the future, is to be filled out fully automatically without presenting the user with the completed form.

The form fill proxy 400a or 400b returns the form to the form fill system 200a or 200b which then makes note of any changes made by the user and adjusts its internal databases and fuzzy logic so that it will be better able to fill out that same form when it is encountered in the future, as will be explained.

In this manner, the system 100 automates the process of filling out personal information forms using a rules based dictionary and learns, over time, how to become better at the process of filling out such forms and how to quickly master new forms whenever they are encountered by using a fuzzy logic artificial intelligence system.

There are two categories of data that can be filled in: Profile data (first name, last name, address, credit card information) are inserted into vendor checkout forms of the type just described. Non-profile data (typically a simple user name and password pair, or PIN, PKI certificate, etc.) are required to be submitted by many systems, such as Microsoft's Hot Mail electronic mail system, to identify a user each time he or she enters a web site. The first time a user receives a form requesting non-profile data, the user enters his or her chosen user name and password (PIN, etc.) manually. After that, such forms are automatically pre-filled by the present system without user intervention.

Dictionary Database

The data structures or databases that underlie the operation of the present invention are shown in FIGS. 10-12.

FIG. 10 presents a high level description of the dictionary database 1000 which contains the rules that are used to guide the filling out of forms. This database is initially pre-loaded with considerable information derived from numerous commercial forms on the Internet; and this information is revised and updated regularly as part of routine system support. In addition, and as a background task, the secure web pages on web sites known to be of interest can be periodically checked out for changes and alterations both in the names and in the contents of the secure web pages that contain forms to be filled out. The dictionary database 1000 may then be altered accordingly, possibly by simply deleting obsolete information or by removing page specific information to cause a page to be re-evaluated using artificial intelligence techniques. It is also possible to have a web crawler or spider search out new priority sites on the Internet looking for other secure form pages to add to the database on an ongoing basis.

The dictionary database 1000 contains a set of rules 1002. Each rule contains (illustratively enclosed within double quotation marks) the title or name of or label for an information field that may appear within a form along with the size of the space within that field where user information may be entered—how many typed characters the field can hold. This information is linked, by a symbolic name or a non-personal identifier (illustratively enclosed in outward pointing arrows used as quotation marks) to specific user information in the wallet database 1100 that is to be inserted into that particular field. For example, Rule 1 associates the fillable form field label “Name:” and field size “12” with a piece of personal information which, in the wallet database 1100, assigned the non-personal identifier ‘<FirstName>’. Likewise, Rule 2, which is more complex in nature, associates the fillable form field labeled “Name” and of size “26” with a string of two user data values identified by non-personal identifiers taken from the wallet database 1100 and conjoined together by a space, namely: ‘<FirstName>“”<LastName>’, where the inserted space is enclosed within double quotation marks and the entire string value to be assigned to this field is enclosed with single quotation marks. (As those skilled in the art will recognize, the actual data base will use very different ways to represent all of these values and relationships.) In a similar manner, numerous rules contained within the dictionary database 1000 will associate numerous different fillable form field labels with different wallet database data values identified by some non-personal identifier or symbolic name assigned to the wallet database data values.

Note that the rules applicable to different forms may sometimes conflict with one another. Two rules may assign different wallet data values to the same field label, since these rules may be used in conjunction with entirely different forms. Such ambiguities need to be resolved by the artificial intelligence system's fuzzy logic in the case of a newly-encountered form that the system may be called upon to try and fill in.

The second part of the dictionary database, at 1004, are associations between the Internet addresses of particular forms and the rules that are applicable to those specific forms. For example, a secure form having a particular address on the Internet is associated with the Rules 1, 3, and 4, as shown, meaning those are the rules that are to be used to control the completion of that particular form by the rules engine 220.

Wallet Database

FIG. 11 describes the wallet database 1100. In the preferred embodiment of the invention, the wallet database is an SQL relational database management system typically maintained on a separate and secure computer that may service several different form fill systems 200 such as the two 200a and 200b shown in FIG. 1. As an alternative, the wallet database could belong to an individual user and be a part of the user's browser 108 or 114 or be a part of the user's PC 110 or wireless telephone or P.D.A. 106 or other user device, or it could be part of the operating system 112 or 118. The wallet database 1100 could alswo be loaded on a special chip on a PC 110 or on a special phone or P.D.A. chip on a wireless telephone or P.D.A. 106. The wallet 1100 does not have to be called a “wallet,” but it can be any data base, having any name, that serves essentially the same purpose as the wallet 1100. As another variation, the wallet database 1100 may be a database containing equivalent personal information that is maintained by a third party. All of these, as well as other variations, come within the scope of the present invention.

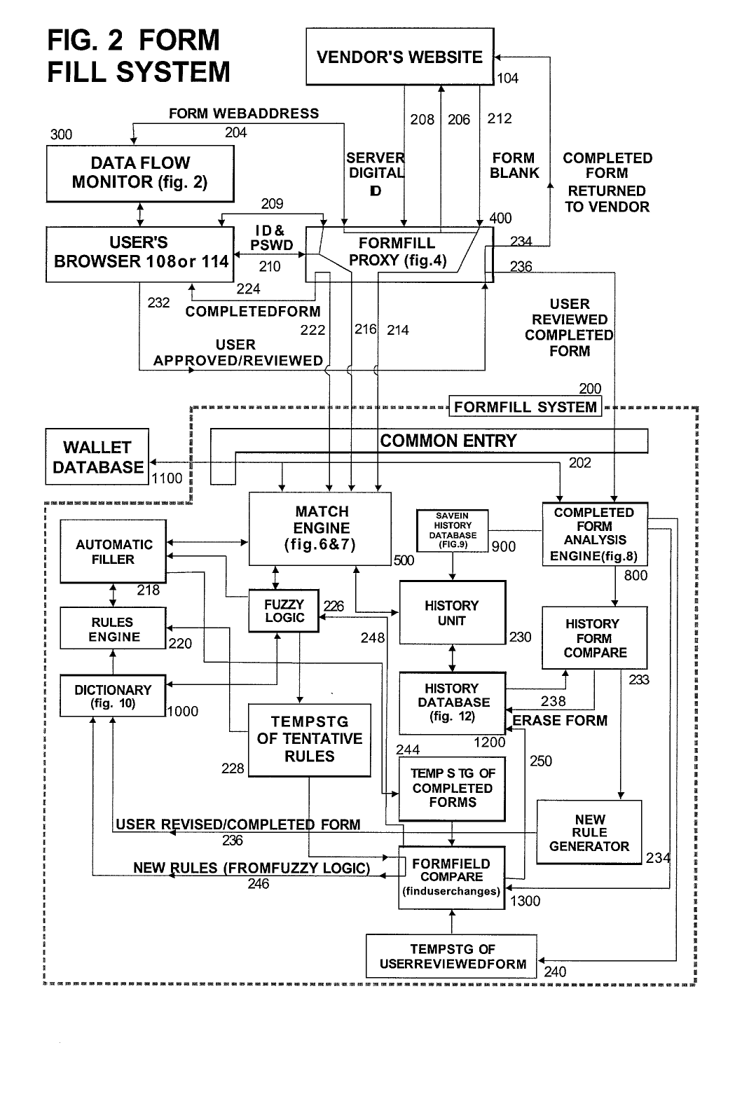

The actual interconnection between the wallet databases 1100 and the form fill systems 200a or 200b in the preferred embodiment of the invention, and clearly not the only way possible of establishing such a connection, is by the wallet database 1100 being designed to act as an Internet “client” to the form fill systems 200a and 200b, which act as “servers” to the wallet database. The wallet database 1100, acting as “client”, requests the form fill system 200a or 200b to provide it with a query of the wallet database 1100. These calls to the form fill systems 200a and 200b made by the wallet database 1100 are addressed to the common entry 202 (FIG. 2) of the systems 200a and 200b in exactly the same manner as the way in which calls by the form fill proxies 400a and 400b, acting as clients, are addressed to the common entry 202 of the respective systems 200a and 200b. Thus, the form fill systems 200a and 200b have only one standard common entry 202 to which all requests from all clients are submitted. In response to requests received from the wallet database 1100, the form fill systems 200a and 200b simply hold the request until such time when there is a need to retrieve information relating to a particular user, at which point the wallet database 1100 is called upon to provide the needed information, still acting as if it were a client (when it is really a server).

As shown in FIG. 11, every block of information within the wallet database 1100 begins with a user I.D. and a user password (or an equivalent PIN, PKI certificate, biometric, SIM Toolkit, etc) which must be provided, or else the data within the wallet is not provided and is kept secure. All communication with the wallet database 1100 is done using secure Internet data transfer protocols to prevent interception and misuse of the personal data. In addition, since interactions between the wallet database 1100 and the form fill systems 200a and 200b are always initiated by the wallet database 1100 acting as a “client,” it is impossible for any other external system ever to get into the wallet database 1100, since that database does not accept any queries from external systems other than ones that the wallet database 1100 itself contacts in its role as a client. In addition, because the system elements do not have public internet addresses, they are neither visible nor accessible from outside the system.

For each user, the wallet database 1100 contains the non-personal identifiers or symbolic names of data elements together with the literal values of those elements which are provided by the particular user during sessions when the user accesses and updates or corrects the contents of the wallet database 1100. The method whereby the user gains access to, registers and corrects the wallet database is as follows: The user uses a User name and Password (or equivalent PIN, PKI certificate, biometric, SIM Toolkit, etc.) to access the secure server that contains all the information in their wallet. The user can access the server from a pc web browser (such as MS Internet Explorer or Netscape Navigator) or from a wireless device browser (such as the phone.com UP.browser). With the account User name and Password (or the equvalent), the wallet owner can add, modify or delete any information stored in their wallet.

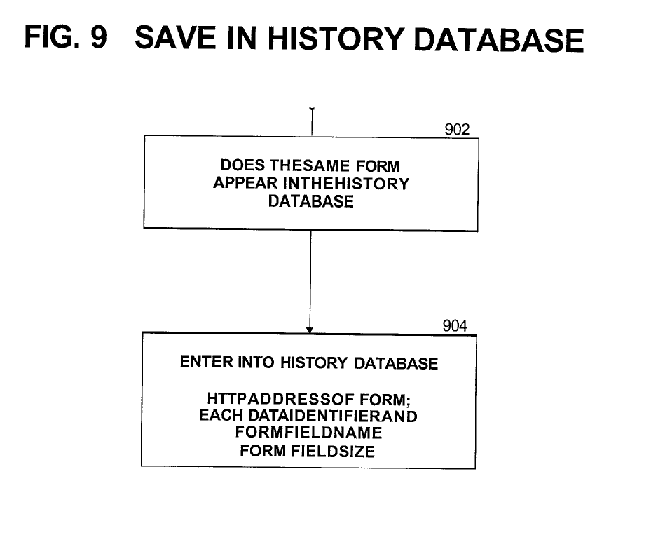

Accordingly, at 1102 within the wallet database 1100, the user I.D. “JJONES” and user password “SCZTQMW” are linked to a series of non-personal or symbolic data identifiers and associated literal values. For example, the non-personal identifier or symbolic name ‘<FirstName>’ is associated with the literal value “Jerry”. In addition to such user profile data (first name, last name, address, credit card information, etc.), and while not shown in FIG. 11, the wallet database for a particular user will also contain user names and passwords (PINs, etc.) that the user has, at one time or another, provided to a particular sign-on form for services such as Microsoft's Hot Mail electronic mail service or other types of services requiring user I.D.s and passwords (or PINs, etc.). As will be explained, this information is captured by the history unit 230 (FIG. 9) and is stored in the wallet database entry for the user. If such a form is encountered several times, then rules are generated and added to the dictionary database 1000 and linked to the web address of that particular form, as will be explained below.

The History Database

The history database is shown at 1200. Entries in the history database 1200 are ultimately replaced by rule entries in the dictionary database 1000 when a standard rule is applicable. The history database typically will contain information relating to two types of sites: sites with forms that have only been encountered once or possibly twice or just a limited number of times and that the system has not yet fully assimilated into the rule collection contained within the dictionary database 1000; and sites with forms that contain non-profile data unique to the specific site. A typical history database entry 1202 contains the web address of a secure tillable form followed by an indication, such as “copy 1”, of which copy of the relevant information for the form this is, if several copies are stored in the history database. Linked to the form name are field labels found within the form together with the non-personal identifiers or symbolic names of data values that the history system has determined a user placed into the form at the blank locations indicated by each field name. Accordingly, if a user filled in the field labeled “Name” with the user's first name, a space, and the user's last name, then the history database will contain, linked to the web address of that form, an indication of the field label “Name” together with the wallet database symbolic names of the literal data that the user has provided. In this case, the field label “Name” would be associated with ‘<FirstName>““<LastName>’. In this manner, and without invading or threatening the privacy of the personal information of any user, the history database can keep a record of forms encountered only once or twice, of their web addresses, of their field labels, and of what symbolic information a particular user has placed into those fields when filling out the form. Any data not identified as a symbolic name will be stored in the History Database 1200 as a string and used accordingly when the specific web address is encountered by the relevant user. Any data that is stored as a string is subject to future identification as a symbolic name.

The Form Fill System—Filling in the Form

FIG. 2 presents an overview of the form fill process, illustrating symbolically with lines the various information flow paths between the various software elements of the system and the various databases described above. The elements of the form fill system 200, which corresponds to both 200a and 200b in FIG. 1, are shown enclosed within a dashed line in the central and lower portions of this FIG.

The form fill system 200 has a common entry point 202 which may be called by any client using the Internet protocol and knowing the system's Internet address. Its normal clients include the wallet SQL relational database management system (the wallet database 1100), which calls upon the system 200 to request that the wallet database 1100 be sent a request for client information, for the reasons explained above. Its other clients are one or more form fill proxies 400 (400a and 400b in FIG. 1). While both the form fill proxy 400 and the wallet database 1100 call to the same common entry point 202 of the system 200, these calls are accompanied by data which distinguishes three different types of calls: those from the wallet database 1100, which are suspended until the match engine 500 or the complete form analysis engine 800 need information from the wallet database 1100; those from the form fill proxy 400 directed to the match engine 500 requesting that a form be filled out and returned; and those from the form fill proxy 400 with a completed form, reviewed and revised by the user, directed to the completed form analysis engine 800 requesting that the user reviewed and revised form be analyzed and used to improve the future operation of the form fill system 200.

With reference to FIG. 2 and as explained above, the system comes into operation when a user's browser 108 or 114 receives a command from the user to download a secure form that needs to be filled out. The user's browser 108 generates an “https:// . . . ” document retrieval command or its equivalent under the WAP protocol. This command is intercepted by a data flow monitor 300 (300a or 300b in FIG. 1) and is routed over the path 204 to the form fill proxy 400. The form fill proxy 400 rebroadcasts this request to the vendor's web site 104 over the path 206 and receives back the server's digital I.D. which flows over the return path 208. The form fill proxy 400 verifies the identity and security of the vendor's web site 104. If the vendor's web site is not secure, the form fill proxy 400 displays a warning message to the user and terminates its activities.

If the vendor's web site is properly identified and verified, the form fill proxy 400 requests cookies from the user's browser 108 or 114 that identify the user in a way that permits access to the user's personal information in the wallet database 1100. If such cookies are present, this means that the user has previously been authenticated during the current user session, and so there is no need to query the user for an I.D. and password (or PIN, PKI certificate, etc.) at this time. The cookie request travels over the path 209 to the user's browser 108 or 114. If no cookies are found, then the form fill proxy 400 sends to the user's browser 108 or 114 over the path 210 a fill-in form requesting the user to submit a wallet user name and password (or equivalent PIN, PKI certificate, biometric, SIM Toolkit, etc.). In this manner, the form fill proxy 400 verifies the identity of the user. If the user name and password (or equivalent) are invalid, then the program terminates, displaying an appropriate error message to the user. Next, over the path 212, the form fill proxy 400 downloads, in a secure manner, the blank form from the vendor's web site 104.

The user identification information and the blank form are respectively transferred by the form fill proxy 400 over the respective paths 216 and 214 through the common entry 202 of the form fill system 200 to the match engine 500 which now gains program control.

Following carefully scripted rules of precedence, the match engine 500 now attempts to fill out the form. First, the match engine 500 passes the form to an automatic filler program 218 which calls upon a rules engine 220 to look up the form's web address in the dictionary database 1000, to locate any set of rules associated with that form's web address within the dictionary database 1000, and to use those rules to fill out the form. If a set of rules are found in the dictionary 1000 associated with this form's web address, then the form is filled out in accordance with those rules. Prior to returning the completed form to the user, the history unit 230 is contacted to check the history database to see if any user specific rules apply to this form. If the existing rules and/or history database provide a completed form then the match engine 500 returns the completed form over the paths 222 and 224 to the user's browser 108 or 114. The completed form is displayed to the user so that the user may verify its correctness and make any necessary or desired changes prior to final submission to the merchant. A copy of the completed form is also passed to the Temp Stg of Completed Forms 244 for later analysis.

If no entry is found for this particular form in the dictionary database 1000, then match engine 500 passes the blank form to the fuzzy logic 226. The fuzzy logic 226 extracts the field labels from the form as well as the field sizes and then compares this information for each entry field in the form to a variety of rules within the dictionary 1000 to come up with a statistical indication of which rule is the most likely to be the correct rule to govern the filling of that entry field of the form. The fuzzy logic 226 is designed to take into account variations in spelling as well as variations in field width when making this determination. If the fuzzy logic 226 is able to come up with a reasonably well matching rule for each entry field in the form, then it alters those rules, as needed, so that they precisely match the needs of this particular form, and then passes the rules to the automatic filler 218 which uses the rules, plus the rules engine 220, to fill out the form. Some of these rules will usually be newly-generated rules developed by the fuzzy logic system to match the field labels and sizes of the new form, while other of these rules may be existing rules that happen to match the form precisely. The fuzzy logic 226 places these rules into a temporary storage area 228 pending user review and possible revision of the entries made into the form in accordance with these rules. The automatic filler 218 places the completed form prepared using fuzzy logic 226 generated rules in Temp Stg of Completed Form 244 pending user review and possible revision of the entries made in the form. Then the fuzzy logic 226 returns the completed form to the match engine 500. Prior to returning the completed form to the user, the history unit 230 is contacted to check the history database to see if any user specific rules apply to this form. Following completion by fuzzy logic 226 and history unit 230, the form is returned over to paths 222 and 224 to the user's browser 108 or 114 for review and possible correction by the user prior to final submission to the merchant.

If the fuzzy logic 226 is unable to substantially match all of the entry fields in the form with likely rules, then the match engine 500 passes the form on to the history unit 230 which searches its history database 1200 to see if the same form has been encountered and filled out before by this user or by some other user. If so, then an exemplary form can be found and retrieved from the history database 1200 and filled in simply by retrieving user specific literal data from the wallet and placing it into the fields within the form labeled as indicated by the information 1202 found within the history database entry for that form, as was explained above. Then the form is returned by the match engine 500 over the paths 222 and 224 to the user's browser 108 or 114 for review and possible revision.

If this form and site have never been encountered before, and if no existing rules match the requirements necessary to complete any part of the form, then the fuzzy logic engine cannot complete any fields and the form and site has no entry in the history database 1200. In this case, then the match engine 500 simply transfers the blank form over the paths 222 and 224 to the user's browser 108 or 114 for completion by the user without any automated assistance.

The Form Fill System—Adapting to User Feedback

After a form has been checked over and possibly revised by the user with the browser 108 or 114, a completed form is returned over the path 232 to the form fill proxy 400, which passes it on over the path 234 to the vendor's web site 104 where the form is processed by the vendor in an appropriate manner. Further communication then occurs directly between the vendor's web site 104 and the user's browser 108 or 114 without further intervention by the form fill proxy 400. If the form is rejected or returned due to an error, the form fill process is repeated. If no changes can be identified, the form is returned to the user for manual modification.

The form fill proxy 400 also sends the user reviewed and revised form over the path 236 through the common entry 202 of the form fill system 200 to the completed form analysis engine 800. Since the user is no longer awaiting action from the form fill system 200, further analysis of the form and of the user's changes may be carried out at a more leisurely pace and used to modify and refine the operations of the system 200 to give better performance in response to later requests for assistance in filling out this and other forms. This can, if necessary or desirable, be carried out as a “background” activity or one interruptible by the more time critical tasks carried out by the match engine 500 while the user is waiting to view a form.

The completed form analysis engine 800 first determines what type of processing, if any, this completed form received from the match engine 500 before it was returned to the user's browser 108 or 114.

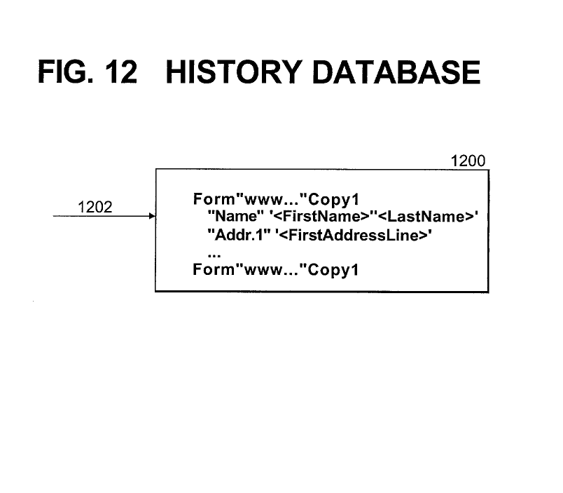

If this is the first time that this particular form had ever been encountered, and if the match engine returned it to the user's browser 108 or 114 with nothing filled in, then the completed form analysis engine 800 simply saves the form in the history database 1200 by calling upon a save in history database program 900 to carry out the following steps: First, the web address of the form is determined. Second, the field labels within the form are retrieved and identified. Third, the data entered by the user opposite each field label is looked up in the user's wallet database 1100; and if a match can be found, then the actual literal information (name, address, etc.) is removed and is replaced by the wallet database's non-personal identifier or symbolic name for that particular literal data element. For example, “Jack” would be replaced by ‘<FirstName>’. In this manner, the form is reduced to the form shown at 1202 in FIG. 12 and is passed on to the history unit 230 for storage in the history database 1200. In this manner, there is no personal information related to wallet database information kept in the history database 1200, but only the wallet database non-personal identifiers or symbolic names for personal information that is stored in the wallet.

If a given form had been encountered before, and if the match engine relied upon the history unit 230 to complete the form for this user, then the completed form analysis engine 800 proceeds as just described to save the form in the history database 1200, but now the history database 1200 contains two or more copies of this particular form. The completed form analysis engine 800 then calls upon a history form compare system 233 to compare the multiple copies of the form within the history database 1200 to see if the versions filled in by different users match. If at least two copies of the form are present, and if the two or more versions of the form in the history database match, both as to the field labels and sizes and as to the personal information non-personal identifiers or symbolic names that are associated with those field labels, then the assumption is made that the forms have been correctly analyzed. The history form compare system 233 then generates a new set of rules for this particular form using a new rule generator 234 which places the new rules into the dictionary 1000, feeding them over the path 236. The history form compare system 233 then sends an erase form command over the path 238 to erase all copies of this particular form from the history database 1200 that match the newly generated rules. In the future, this form will be filled in by the automatic filler 218 through use of the rules engine 220. The new rules apply to all users, but the new rules will be superceded by an exception maintained in the history database where the entry for a particular user does not match the new rules.

However, if the forms retrieved from the history database 1200 do not match, and if the history form compare system 233 is not able to obtain majority voting as to how each field of the form is to be filled in, then the history form compare system 233 leaves the forms in the history database and does not attempt to generate new rules, but postpones further processing of that form until one or more additional copies of the form have been received from users.

If a given form was prepared using the fuzzy logic 226 under the control of the match engine 500, then the completed form analysis engine 800 places the user reviewed and revised form into a temporary storage of user reviewed form area 240 and calls upon a form field compare program 1300 to compare the user revised form 240 with the form as actually prepared by the fuzzy logic system, which is stored temporarily at 244. The two forms are compared field by field. With respect to a given field, if the user did not change the entry made by the fuzzy logic system 226, then the literal values in that field will match. In that case, the form field compare system 1300 transforms the tentative rules for that particular field of that particular form from the temporary storage area 228 over the path 246 and into the dictionary 1000 for use whenever that form is encountered in the future. (Note that multiple copies of duplicate rules do not need to be retained—a single rule may be linked to several different forms.) However, if some of the literal values for a given field do not match, then the user has changed the contents of that field. The form field compare system 1300 then does not transfer over the tentative rules for that field to the dictionary 1000. If the literal value supplied by the user can be found within that user's wallet data, then a corrected rule can be generated and transferred over to the dictionary 1000. Otherwise, the tentative rule is simply discarded and the form inputs for those fields where no rule can be generated are passed on from form field compare 1300 on path 250 to the history database 1200. The form field compare 1300 advises the fuzzy logic 226 over path 248 of its failure to generate a proper rule so that the fuzzy logic 226 may adjust itself to try a different strategy the next time that same form and same field, or a similar field, are encountered. If rules for all of the fields of that particular form are placed into the dictionary database 1000, then the dictionary database 1000 is adjusted so that the automatic filler program 218 and the rules engine 220 will fill out that form the next time it is encountered. But if some rules are still missing for fields in this form, the dictionary database 1000 is marked so that the fuzzy logic is still used to fill out this form the next time it is encountered.

The Data Flow Monitor

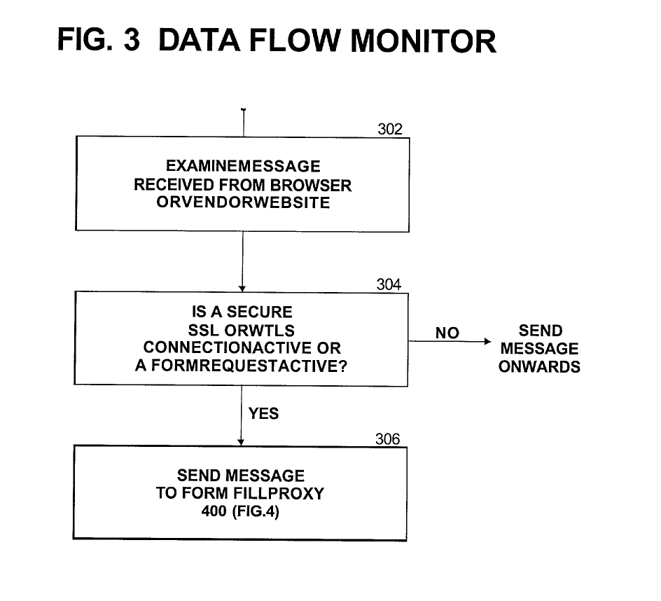

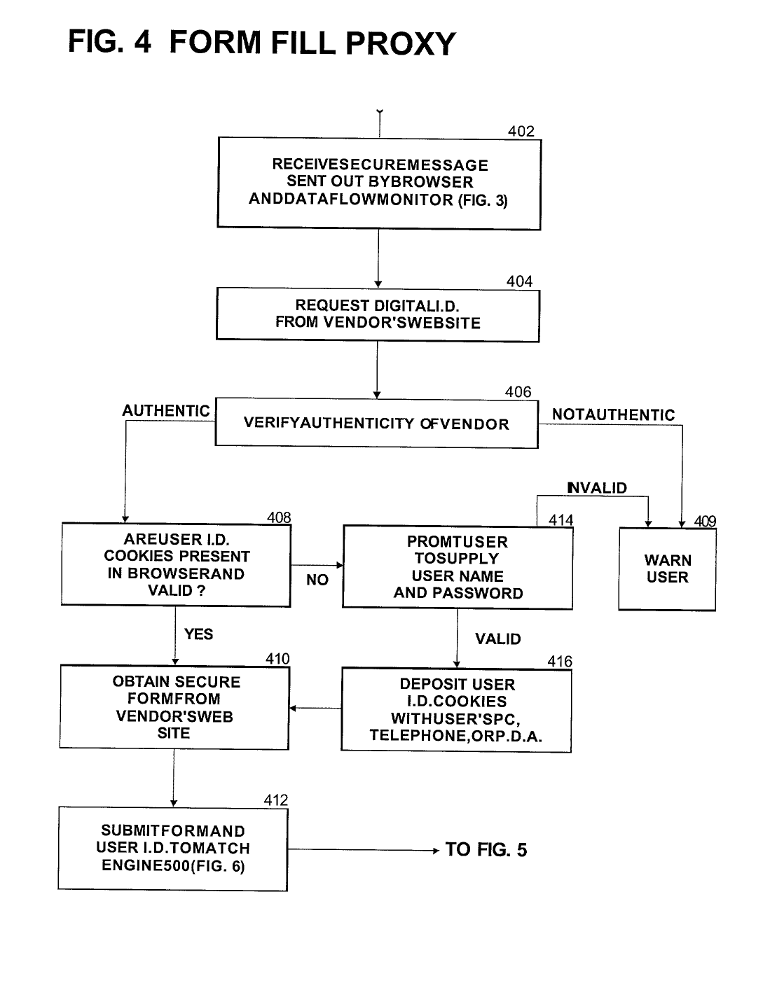

FIG. 3 presents a detailed flow diagram of the functions performed by the data flow monitor 300a and 300b in FIG. 1 (300 in FIGS. 1 and 2).

At step 302, the data flow monitor examines each message that is transmitted by the user's browser 108 or 114 back to the Internet 102. There are many ways in which this can be done. In the preferred embodiment of the invention, the data flow monitor is embedded within the TCP/IP network protocol stack at a position where it is able to monitor TCP packets to determine either to which socket they are addressed within the vendor's server by socket number or what HTTP or WAP command they contain. When a message is found that is requesting secure communication with a server to download a document, as through the SSL (Secure Sockets Layer) protocol or the WTLS Wireless Transport Layer Security protocol (step 304 in FIG. 3), then at step 306, the web address of the requested secure form is forwarded to the form fill proxy 400 (400a or 400b in FIG. 1). In this manner, all requests for secure access to forms are intercepted by the data flow monitors 300a and 300b and are diverted to the form fill proxy 400. Part of the data flow monitor may also be resident upon a server, such as the server containing the ISP proxy and gateway 116 and 122 or the server containing the form fill proxy 400.

The Form Fill Proxy

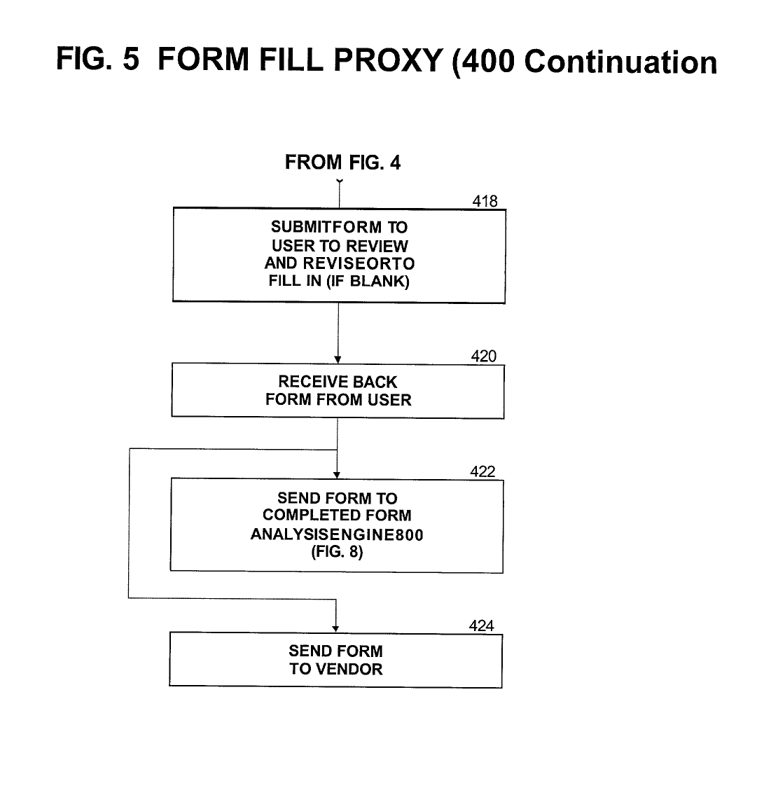

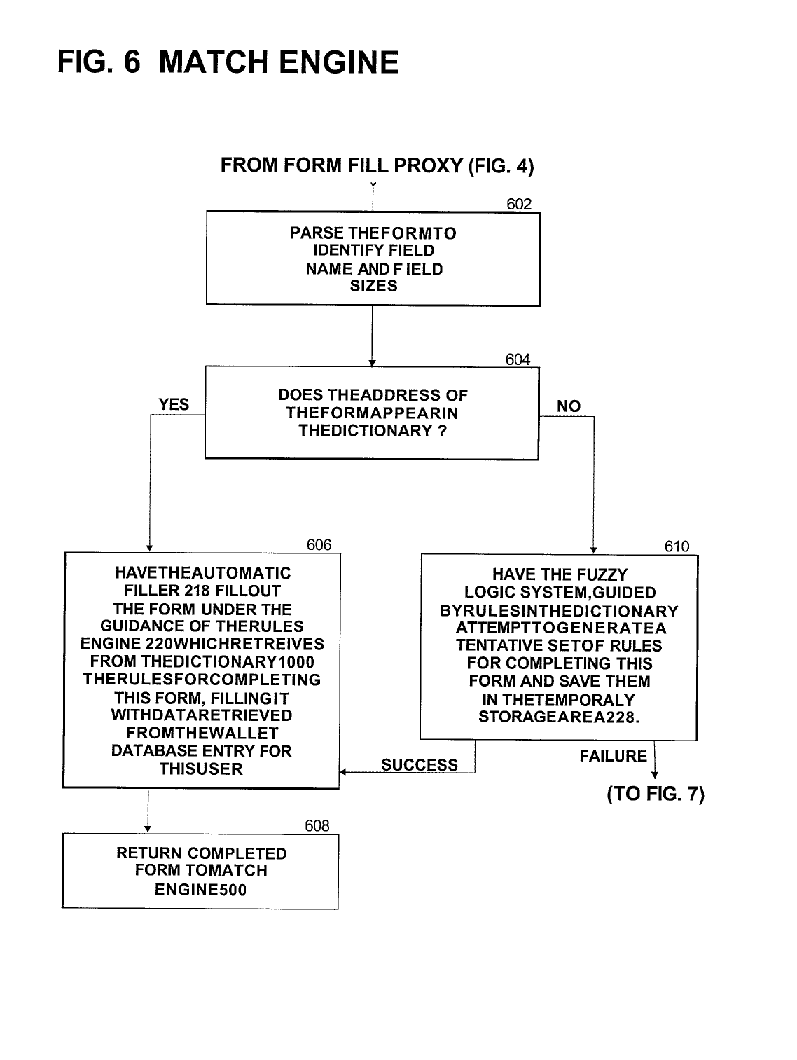

FIGS. 4 and 5 together present a detailed flow diagram of the activities of the form fill proxy 400 (400a and 400b in FIG. 1). At step 402, the form fill proxy 400 is placed into operation when it receives from the data flow monitor 300 (300a and 300b in FIG. 1) a request to establish secure communication sent from a user to a vendor's web site. Typically, these requests are ones where the address of the server and document is prefixed by “HTTPS://”.

At step 404, the form fill proxy 400 takes over the handshaking protocol to establish a secure connection under SSL or WTLS and begins by requesting the vendor's web site 104 to present its digital I.D. 128 for verification. At step 406, the vendor's digital I.D. 128 is verified. If it is not valid, then at step 409 a warning message is presented to the user upon the browser 108 or 114, and the proxy 400 exits without taking any further steps. While these initial steps are carried out by the form fill proxy 400 in the preferred embodiment of the invention, they could just as well be carried out by the user's browser prior to intervention by the data flow monitor, or they could be carried out by a stub program within the form fill system 200a or 200b.

Next, the form fill proxy 400 requests from the user's browser 108 or 114 user I.D. cookies that may have been placed there during an earlier secure access to a vendor during the present operating session. If such cookies are found, then at step 410, the personal information form 126 is obtained and downloaded from the vendor's website 104; and at step 412, the form is submitted, along with the user's I.D. information, to the match engine 500 within the form fill system 200 through the common entry 202.

If user I.D. cookies are not found at step 408, then the form fill proxy 400, at step 414, prompts the user for a user name and password (or equivalent) and must check that password (or equivalent) against stored information for the user contained in the wallet database 1100. If the user name and password (or equivalent) are invalid, then the program 400 terminates, displaying an appropriate error message to the user. If they are valid, then at step 412, I.D. cookies are deposited on the user's PC 110 or wireless telephone or PDA 106, and program control continues at step 410 and 412 where the personal information form 126 is downloaded from the vendor's web site 104 and is submitted to the match engine 500.

With reference to FIG. 5, after the match engine 500 has processed the form and returned it to the form fill proxy 400, the form fill proxy 400 at step 418 sends the form on to the user's browser 108 or 114 where the user may review the form entries and, possibly, revise it. When the user transmits the form to the vendor's website 104, it is again captured by the form fill proxy 400 from the user at step 420. The form is sent on to the completed form analysis engine 800 within the form fill system 200 through the common entry 202 (step 422). The completed form is also sent on to the vendor's web site 104 where it is analyzed and processed to complete the user's transaction (step 424).

The Match Engine

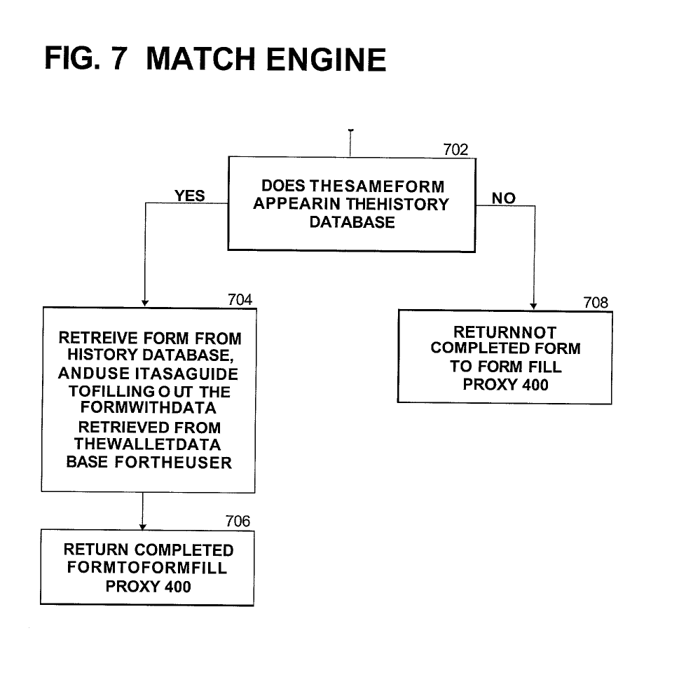

FIGS. 6 and 7 present a detailed flow diagram of the steps carried out by the match engine 500 within the form fill system 200 in response to the receipt from the form fill proxy 400 of a vendor's secure personal information form 126 that needs to be filled out, along with user identification information.

Referring now to FIG. 6, at step 602, the form is parsed to identify within the form the labels for the individual data entry fields and the sizes of those fields. Next, at step 604, the dictionary 1000 is checked to see if the name of the form appears in the dictionary along with a set of rules, as indicated at 1004 in FIG. 10. If so, and if the form's labels and sizes match those in the set of rules, then at step 606 the form is passed to the automatic filler 218 which fills out the form under the guidance of the rules engine 220. The rules engine 220 retrieves from the dictionary 1100 the rule specifically applicable to completing each field of this form and applies the rule using personal information that is retrieved from the wallet database 1100 entries for this particular user. The completed form is then returned to the match engine 500.

If a dictionary 1000 entry for this form is not found, then an attempt is made to fill out the form using rules in the dictionary that may not match the form precisely and that may be somewhat contradictory because they originated from many different forms. At step 610, the fuzzy logic 226, working with the labels and sizes of fields in the form, tries to find the best match between those labels and field sizes and the rule information contained within the dictionary 1000. The fuzzy logic 226 may compare the spelling of rule labels to those found in the form and find the closest match in that regard, if an exact match cannot be found. In this manner, the fuzzy logic system generates a new tentative set of rules and stores them in a temporary storage area 228. If this effort is successful, then program control continues its step 606 where the automatic filler 218 is called upon to fill out the form using the rules engine 220 governed this time by the tentative rule set in the storage area 228. Once again, the completed form is returned to the match engine 500

After the form passes through the automatic filler and if the fuzzy logic system is unable to come up with good matches between existing rules and the names and sizes of the fields in the new form, then (step 702 in FIG. 7) a check is made by the history unit 230 to see if a copy of the form exists in the history database 1200. If so, information comparable to that shown at 1202 in FIG. 12 is retrieved from the history database entry for that form and is used to guide the completion of the form with personal information taken from the wallet database 1100 of the user (step 704). The completed form is then returned from the match engine to the form fill proxy 400 (step 706), which returns it to the user's browser 108 or 114 for review and possible revision.

If no prior copy of the same form exists in the history database, then at step 708 in FIG. 7, the form is simply not completed but is returned from the match engine to the form fill proxy 400 which sends on the incomplete form to the user's browser 108 or 114 to be filled out completely by the user.

The Completed Form Analysis Engine

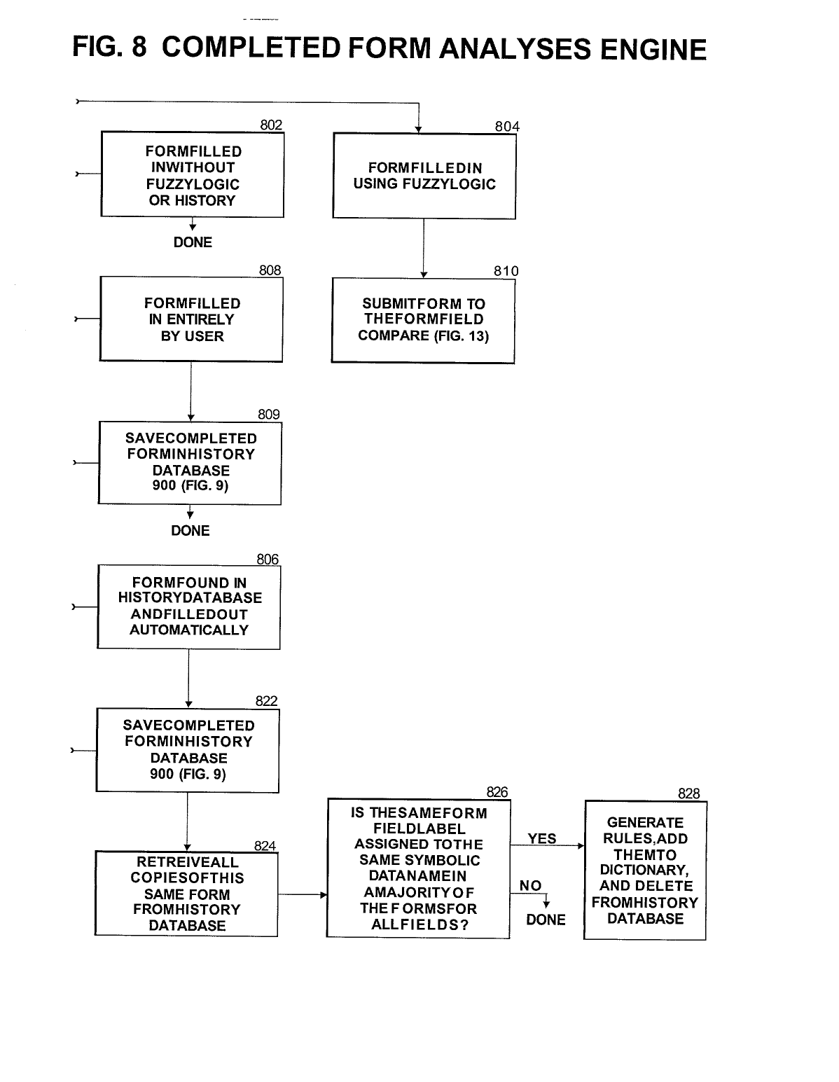

FIG. 8 presents a block diagram of the steps performed by the completed form analysis engine 800, which is called upon by the form fill proxy 400 to evaluate a form after the user has reviewed and possibly revised it, to note any revisions and to correct and improve the future ability of the form fill system 200 to complete this and other forms.

Program control begins with one of the entry points 802, 804, 806, or 808 depending upon how this particular form was treated previously by the match engine 500. The entry point 802 corresponds to the situation when the form was filled out by the automatic filler 218 and rules engine 220 without the assistance of either the fuzzy logic 226 or the history unit 230 and the user made no modifications. In that case, no further processing is needed.

Entry point 804 is taken if a particular form was filled out using the fuzzy logic 226. In that case, program control advances from the completed form analysis engine 800 to a form field compare program 1300.

The entry point 806 corresponds to the case when the match engine 500 found the form within the history database 1200 and filled the form in automatically using a prior filled-out copy of the form as a guide. In this case, at step 822, the completed form is saved in the history database, as will be explained below (FIG. 9).

Next, at step 824, all copies of the same form are retrieved from the history database 1200 and are compared, field by field, at step 826, by the history form compare program 233 to each other and to the newly completed form. Each field in each form is compared to the fields in the remaining forms. The history form compare program 233 asks the question: Is the same non-personal or symbolic data identifier linked to the same form field label in a majority of the forms or (preferably) in all of the forms? If not, then the forms are left in the history database 1200, and program control returns to the form fill proxy program 300.

If, for each and every field, the majority of the form field entries match, then at step 828, the new rule generator 234 generates rules governing the filling of the fields of this new form; and the generator 234 adds the new rules to the dictionary database 1000 along with the web address of the form and the list of rules. Finally, the copies of this form in the history database 1200, having served their purpose to govern the generation of new rules, are deleted from the history database 1200. Then program control terminates in the program 200 and is returned to the form fill proxy program 400.

Entry point 808 corresponds to the case where the form is returned blank and filled in entirely by the user. In this situation the form is transferred to the save in history database 900.

Saving a Form in the History Database

FIG. 9 presents a block diagram of the save in history database program 900 that saves a completed form that has been reviewed and analyzed by the user in the history database 1200. The program 900 begins at step 902 by scanning the form, locating all of the field labels or identifiers. It then locates the corresponding literal personal information in each field of the form and, by looking up that personal information in the wallet database 1100 (1102 in FIG. 11) for this user, takes out the personal information such as “Jerry” and replaces it with non-personal identifiers or symbolic names for the information, such as ‘<FirstName>’, and thereby transforms the actual completed form into a representation of the form such as that shown in 1202 in FIG. 12, where the web address of the form is followed by its field labels each linked to the non-personal identifier or symbolic name of the content of that field.

Finally, at step 904, the history unit 230 is called upon to place all of this information into the history database 1200 for use in guiding form completion the next time the same form is encountered.

In the case of a first encounter with a form, such as the user name and password (or equivalent identifier) requesting form of Microsoft's HotMail service, that simply requests a user name and password (or equivalent), the literal data entered by the user may and probably will be new and will not be found in the wallet database 1100. In this special case, the history data base program 900 creates new non-personal identifiers or symbolic names for the literal data and actually commands the wallet data base to accept both the newly-created non-personal identifiers or symbolic names and the literal values and to save them as part of the data stored for this particular user. These newly created non-personal identifiers or symbolic names are then linked with the form, along with the field labels, when the form is added to the history data base. In this manner, user names and passwords (or their equvalent) may be gathered from users and saved in the wallet database 1100.

Such forms are especially marked as ones that contain “non-profile data.” Accordingly, the system knows that whenever it encounters this form again for a new user, it must add new data fields to the user's wallet database 1100 entry to provide room for the storage of a new user ID and password pair (or their equivalent) for this user.

Form Field Compare

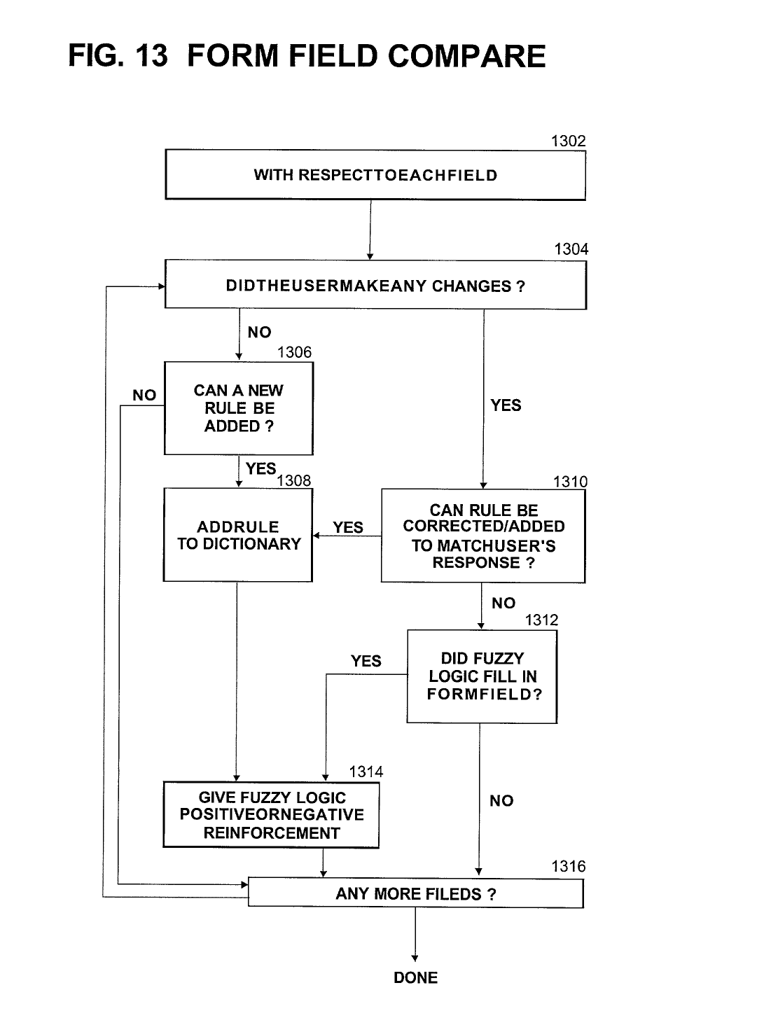

FIGS. 13 represent the detailed diagrams of the work carried out in the Form Field Compare module. The form field compare 1300 compares an unaltered copy of the form as completed and stored in temporary storage at 244 with a copy of the user's reviewed and revised form stored at 240. Each separate field in one form is compared to its counterpart in the other form to see if the user made any changes.

At step 1302, with respect to each field: A test is performed at step 1304 to see if the user made any changes to the field. If no changes were made, then the system tests whether the fuzzy logic entry is unchanged. If a fuzzy logic entry is unchanged, then a new rule is added to the dictionary database 1000 (steps 1306 and 1308). If the unchanged entry was from an existing rule, then the system skips ahead to look for any more fields to compare (step 1306). If a user change did take place, then the corresponding tentative rule contained in the database 228 is corrected, if possible, so as to complete the form as the user has done (steps 1310 and 1308). This correction can be made if the literal value entered by the user can be found, and its non-personal identifier or symbolic name determined, by scanning the user's data in the wallet database 1100. If the rule cannot be corrected (step 1310), then the rule is discarded (step 1308 is skipped). If there was no user change, or if a corrected rule can be generated, then the tentative or corrected rule is transferred from the temporary storage at 228 to the dictionary 1000 and is linked to the name of the form within the dictionary (step 1308). Finally, at step 1314, the fuzzy logic system 226 receives positive or negative feedback on its performance in generating each rule that it generated. If a rule cannot be corrected, then the system asks if fuzzy logic provided the rule (step 1312). If so, fuzzy logic is given feedback. If not, no feedback is given to fuzzy logic. This feedback alters the fuzzy logic system so that in the future it performs in a slightly different manner, de-emphasizing the possibility of making the wrong choice it just made in the future, and perhaps generating a correct rule the next time.

Note that while some of the tentative rules and some corrected rules are added to the dictionary data base 1000, the document entry in the dictionary will still be disabled to force continued use of the fuzzy logic 226 the next time this same form is encountered until the dictionary 1000 contains confirmed rules for all of the fields in this form.

At step 1316, if there are any more fields to be checked, program control returns to the step 1304. Otherwise, the form fill system 200 returns program control to the form fill proxy 400 and suspends execution.

While the invention has been described with specific embodiments, other alternatives, modifications and variations will be apparent to those skilled in the art. Accordingly, it is intended to include all such alternatives, modifications and variations set forth within the spirit and scope of the appended claims. reviewed and revised form stored at 240. Each separate field in one form is compared to its counterpart in the other form to see if the user made any changes.

At step 1302, with respect to each field: A test is performed at step 1304 to see if the user made any changes to the field. If no changes were made, then the system tests whether the fuzzy logic entry is unchanged. If a fuzzy logic entry is unchanged, then a new rule is added to the dictionary database 1000 (steps 1306 and 1308). If the unchanged entry was from an existing rule, then the system skips ahead to look for any more fields to compare (step 1306). If a user change did take place, then the corresponding tentative rule contained in the database 228 is corrected, if possible, so as to complete the form as the user has done (steps 1310 and 1308). This correction can be made if the literal value entered by the user can be found, and its non-personal identifier or symbolic name determined, by scanning the user's data in the wallet database 1100. If the rule cannot be corrected (step 1310), then the rule is discarded (step 1308 is skipped). If there was no user change, or if a corrected rule can be generated, then the tentative or corrected rule is transferred from the temporary storage at 228 to the dictionary 1000 and is linked to the name of the form within the dictionary (step 1308). Finally, at step 1314, the fuzzy logic system 226 receives positive or negative feedback on its performance in generating each rule that it generated. If a rule cannot be corrected, then the system asks if fuzzy logic provided the rule (step 1312). If so, fuzzy logic is given feedback. If not, no feedback is given to fuzzy logic. This feedback alters the fuzzy logic system so that in the future it performs in a slightly different manner, de-emphasizing the possibility of making the wrong choice it just made in the future, and perhaps generating a correct rule the next time.

Note that while some of the tentative rules and some corrected rules are added to the dictionary data base 1000, the document entry in the dictionary will still be disabled to force continued use of the fuzzy logic 226 the next time this same form is encountered until the dictionary 1000 contains confirmed rules for all of the fields in this form.

At step 1316, if there are any more fields to be checked, program control returns to the step 1304. Otherwise, the form fill system 200 returns program control to the form fill proxy 400 and suspends execution.

While the invention has been described with specific embodiments, other alternatives, modifications and variations will be apparent to those skilled in the art. Accordingly, it is intended to include all such alternatives, modifications and variations set forth within the spirit and scope of the appended claims.

I claim:

1. A system for complying with requests for information received from a network and directed to a user, said system comprising:
a data flow monitor interposed between the network and the user that intercepts such requests;
a wallet database where personal information of one or more users is kept in a secure manner and is associated with non-personal identifiers;
a history database containing at least some previously-completed and user-validated requests in which at least some of the personal information is replaced by the non-personal identifiers to at least partly depersonalize the requests;
a request completion system coupled directly or indirectly to the above elements that accepts such requests, that attempts to fulfill such requests using information obtained from the wallet database through the use of history database records of one or more previously completed, validated copies of the same type of request, and also through asking the user to complete all or those portions of requests not automatically completed and to validate all or those portions of requests automatically completed;
said request completion system further including a completed request analysis engine that can add completed, user verified, and at least partly depersonalized requests to the history database.

2. A system in accordance with claim 1 to which is added
a dictionary database containing rules governing what information, identified by non-personal identifiers, goes where in particular types of requests;
wherein the request completion system also attempts to fulfill such requests using information obtained from the wallet database through the use of rules obtained from the dictionary database specifically applicable to a particular type of request.

3. A system in accordance with claim 2
wherein the request completion system's completed request analysis engine also validates new sets of rules developed through history database request analysis and user validation with respect to a particular type of request, thereby developing from the history database new rules for inclusion in the dictionary database.

4. A system in accordance with claim 3
wherein the request completion system also attempts to fulfill such requests using information obtained from the wallet database through the use of rules obtained from the dictionary database applied using fuzzy logic or artificial intelligence techniques.

5. A system in accordance with claim 4
wherein the request completion system's completed request analysis engine also validates new sets of rules developed through fuzzy logic or artificial intelligence analysis of existing rules, and this engine also can give positive or negative training feedback to the fuzzy logic or artificial intelligence system in accordance with its performance as accepted or corrected by users.

6. A system in accordance with claim 5 which further includes
a validation program coupled to the data flow monitor that determines and validates the source of the request.

7. A system in accordance with claim 6
wherein the validation program also determines and validates the user's identification.

8. A system in accordance with claim 1 to which is added
a dictionary database containing rules governing what information, identified by non-personal identifiers, goes where in requests;
and wherein the request completion system also attempts to fulfill such requests using information obtained from the wallet database through the use of rules obtained from the dictionary database applied using fuzzy logic or artificial intelligence techniques.

9. A system in accordance with claim 8
wherein the request completion system's completed request analysis engine also validates new sets of rules developed through fuzzy logic or artificial intelligence analysis of existing rules and history database request analysis, and this engine also can give positive or negative training feedback to the fuzzy logic or artificial intelligence system in accordance with its performance as accepted or corrected by users.

10. A system in accordance with claim 9 which further includes
a validation program coupled to the data flow monitor that determines and validates the source of the request.

11. A system in accordance with claim 10
wherein the validation program also determines and validates the user's identification.

12. A method for automatically complying with requests for information received from a network and directed to a user comprising the steps of:
establishing a wallet database where user information can be kept secure and can be associated with non-personal identifiers;
establishing a history database where user validated, completed requests may be kept with at least some personal information replaced by non-personal identifiers to at least partly depersonalize the requests;
monitoring the flow of data between the network and the user and intercepting such requests for information;
attempting to complete such requests using information obtained from the wallet database through the use of history database records of one or more completed, validated copies of the same type of request, and through asking the user to complete all or those portions of a request not automatically completed and to validate all or those portions of a request automatically completed; and
following user review and validation or completion or correction of a completed request, analyzing any changes made by the user to add completed, user verified, and depersonalized requests to the history data base.

13. A method in accordance with claim 12 additionally comprising the steps of
establishing a dictionary database containing rules associating non-personal identifiers with specific data fields within specific types of requests; and
attempting to complete such requests using information obtained from the wallet database through the use of rules obtained from the dictionary database applicable to a particular type of request.

14. A method in accordance with claim 13, additionally comprising the step of
following user review and validation or completion or correction of a request, analyzing any changes made by the user to validate any new rules developed through history database record analysis techniques and adding them to the dictionary database.

15. A method in accordance with claim 14, additionally comprising the step of
attempting to complete such requests using information obtained from the wallet database through the use of rules obtained from the dictionary database applied using fuzzy logic or artificial intelligence techniques.

16. A method in accordance with claim 15, additionally comprising the step of
following user review and validation or completion or correction of a request, analyzing any changes made by the user to validate any new rules developed through fuzzy logic or artificial intelligence techniques and adding them to the dictionary database, and to give positive or negative feedback to the fuzzy logic or artificial intelligence system in accordance with its performance.

17. A method in accordance with claim 16, additionally comprising the step of
validating the source of the request.

18. a method in accordance with claim 17, additionally comprising the step of
validating the user's identification.

19. A method in accordance with claim 12, additionally comprising the steps of
establishing a dictionary database containing rules associating non-personal identifiers with specific data fields within requests; and
attempting to complete such requests using information obtained from the wallet database through the use of rules obtained from the dictionary database applied using fuzzy logic or artificial intelligence techniques.

20. A method in accordance with claim 19, additionally comprising the step of
following user review and validation or completion or correction of a request, analyzing any changes made by the user to validate any new rules developed through fuzzy logic or artificial intelligence techniques and adding them to the dictionary database, and to give positive or negative feedback to the fuzzy logic system in accordance with its performance.

21. A method in accordance with claim 20, additionally comprising the step of
validating the source of the request.

22. a method in accordance with claim 21, additionally comprising the step of
validating the user's identification.

23. A system for complying with requests for information received from a network and directed to a user, said system comprising:
a data flow monitor interposed between the network and the user that intercepts such requests;
a wallet database where personal information of one or more users is kept in a secure manner and is associated with non-personal identifiers;
a history database containing at least some previously-completed and user-validated requests in which at least some of the personal information is replaced by the non-personal identifiers to at least partly depersonalize the requests;
a request completion system coupled directly or indirectly to the above elements that accepts such requests, and that attempts to fulfill such requests using information obtained from the wallet database through the use of history database records of one or more previously completed, validated copies of the same type of request;
said request completion system further including a completed request analysis engine that can add completed and at least partly depersonalized requests to the history database.

24. A system in accordance with claim 23 to which is added
a dictionary database containing rules governing what information, identified by non-personal identifiers, goes where in particular types of requests;
wherein the request completion system also attempts to fulfill such requests using information obtained from the wallet database through the use of rules obtained from the dictionary database specifically applicable to a particular type of request.

25. A system in accordance with claim 24
wherein the request completion system's completed request analysis engine also validates new sets of rules developed through history database request analysis with respect to a particular type of request, thereby developing from the history database new rules for inclusion in the dictionary database.

26. A system in accordance with claim 25
wherein the request completion system also attempts to fulfill such requests using information obtained from the wallet database through the use of rules obtained from the dictionary database applied using fuzzy logic techniques.

27. A system in accordance with claim 26
wherein the request completion system's completed request analysis engine also validates new sets of rules developed through fuzzy logic analysis of existing rules, and this engine also can give positive or negative training feedback to the fuzzy logic system in accordance with its performance.

28. A system in accordance with claim 27 which further includes
a validation program coupled to the data flow monitor that determines and validates the source of the request.

29. A system in accordance with claim 28
wherein the validation program also determines and validates the user's identification.

30. A system in accordance with claim 23 to which is added
a dictionary database containing rules governing what information, identified by non-personal identifiers, goes where in requests;
and wherein the request completion system also attempts to fulfill such requests using information obtained from the wallet database through the use of rules obtained from the dictionary database applied using fuzzy logic techniques.

31. A system in accordance with claim 30
wherein the request completion system's completed request analysis engine also validates new sets of rules developed through fuzzy logic analysis of existing rules and history database request analysis, and this engine also can give positive or negative training feedback to the fuzzy logic system in accordance with its performance.

32. A system in accordance with claim 31 which further includes
a validation program coupled to the data flow monitor that determines and validates the source of the request.

33. A system in accordance with claim 32
wherein the validation program also determines and validates the user's identification.

34. A method for automatically complying with requests for information received from a network and directed to a user comprising the steps of:
establishing a wallet database where user information can be kept secure and can be associated with non-personal identifiers;
establishing a history database where user validated, completed requests may be kept with at least some personal information replaced by non-personal identifiers to at least partly depersonalize the requests;
monitoring the flow of data between the network and the user and intercepting such requests for information;
attempting to complete such requests using information obtained from the wallet database through the use of history database records of one or more completed, validated copies of the same type of request; and
adding completed and depersonalized requests to the history data base.

35. A method in accordance with claim 34 additionally comprising the steps of
establishing a dictionary database containing rules associating non-personal identifiers with specific data fields within specific types of requests; and
attempting to complete such requests using information obtained from the wallet database through the use of rules obtained from the dictionary database applicable to a particular type of request.

36. A method in accordance with claim 35, additionally comprising the step of
adding new rules developed through history database record analysis techniques to the dictionary database.

37. A method in accordance with claim 36, additionally comprising the step of
attempting to complete such requests using information obtained from the wallet database through the use of rules obtained from the dictionary database applied using fuzzy logic techniques.

38. A method in accordance with claim 37, additionally comprising the step of
adding any new rules developed through fuzzy logic techniques to the dictionary database, and giving positive or negative feedback to the fuzzy logic system in accordance with its performance.

39. A method in accordance with claim 38, additionally comprising the step of
validating the source of the request.

40. a method in accordance with claim 39, additionally comprising the step of
validating the user's identification.

41. A method in accordance with claim 34, additionally comprising the steps of
establishing a dictionary database containing rules associating non-personal identifiers with specific data fields within requests; and
attempting to complete such requests using information obtained from the wallet database through the use of rules obtained from the dictionary database applied using fuzzy logic techniques.

42. A method in accordance with claim 41, additionally comprising the step of
adding any new rules developed through fuzzy logic techniques to the dictionary database, and giving positive or negative feedback to the fuzzy logic system in accordance with its performance.

43. A method in accordance with claim 42, additionally comprising the step of
validating the source of the request.

44. a method in accordance with claim 43, additionally comprising the step of
validating the user's identification.

45. A system for complying with requests for information received from a network and directed to a user using personal information obtained from a suitable source, said system comprising:
a data flow monitor interposed between the network and the user that intercepts such requests;
a wallet system that, on receipt of a non-personal identifier, can obtain corresponding personal information of one or more users;
a history database containing at least some previously-completed and user-validated requests in which at least some of the personal information is replaced by the non-personal identifiers to at least partly depersonalize the requests;
a request completion system coupled directly or indirectly to the above elements that accepts such requests, that attempts to fulfill such requests using information obtained from the wallet system through the use of history database records of one or more previously completed, validated copies of the same type of request, and also through asking the user to complete all or those portions of requests not automatically completed and to validate all or those portions of requests automatically completed;
said request completion system further including a completed request analysis engine that can add completed, user verified, and at least partly depersonalized requests to the history database.

46. A system in accordance with claim 45 to which is added
a dictionary database containing rules governing what information, identified by non-personal identifiers, goes where in particular types of requests;
wherein the request completion system also attempts to fulfill such requests using information obtained from the wallet system through the use of rules obtained from the dictionary database specifically applicable to a particular type of request.

47. A system in accordance with claim 46
wherein the request completion system's completed request analysis engine also validates new sets of rules developed through history database request analysis and user validation with respect to a particular type of request, thereby developing from the history database new rules for inclusion in the dictionary database.

48. A system in accordance with claim 47
wherein the request completion system also attempts to fulfill such requests using information obtained from the wallet system through the use of rules obtained from the dictionary database applied using fuzzy logic techniques.

49. A system in accordance with claim 48
wherein the request completion system's completed request analysis engine also validates new sets of rules developed through fuzzy logic analysis of existing rules, and this engine also can give positive or negative training feedback to the fuzzy logic system in accordance with its performance as accepted or corrected by users.

50. A system in accordance with claim 49 which further includes
a validation program coupled to the data flow monitor that determines and validates the source of the request.

51. A system in accordance with claim 50
wherein the validation program also determines and validates the user's identification.

52. A system in accordance with claim 45 to which is added
a dictionary database containing rules governing what information, identified by non-personal identifiers, goes where in requests;
and wherein the request completion system also attempts to fulfill such requests using information obtained from the wallet system through the use of rules obtained from the dictionary database applied using fuzzy logic techniques.

53. A system in accordance with claim 52
wherein the request completion system's completed request analysis engine also validates new sets of rules developed through fuzzy logic analysis of existing rules and history database request analysis, and this engine also can give positive or negative training feedback to the fuzzy logic system in accordance with its performance as accepted or corrected by users.

54. A system in accordance with claim 53 which further includes
a validation program coupled to the data flow monitor that determines and validates the source of the request.

55. A system in accordance with claim 54
wherein the validation program also determines and validates the user's identification.

56. A method for automatically complying with requests for information received from a network and directed to a user using personal information comprising the steps of:
establishing a history database where user validated, completed requests may be kept with at least some personal information replaced by non-personal identifiers to at least partly depersonalize the requests;
monitoring the flow of data between the network and the user and intercepting such requests for information;
attempting to complete such requests using the personal information through the use of history database records of one or more completed, validated copies of the same type of request, and through asking the user to complete all or those portions of a request not automatically completed and to validate all or those portions of a request automatically completed; and
following user review and validation or completion or correction of a completed request, analyzing any changes made by the user to add completed, user verified, and depersonalized requests to the history data base.

57. A method in accordance with claim 56 additionally comprising the steps of
establishing a dictionary database containing rules associating non-personal identifiers with specific data fields within specific types of requests; and
attempting to complete such requests using the personal information through the use of rules obtained from the dictionary database applicable to a particular type of request.

58. A method in accordance with claim 57, additionally comprising the step of
following user review and validation or completion or correction of a request, analyzing any changes made by the user to validate any new rules developed through history database record analysis techniques and adding them to the dictionary database.

59. A method in accordance with claim 58, additionally comprising the step of
attempting to complete such requests using the personal information through the use of rules obtained from the dictionary database applied using fuzzy logic techniques.

60. A method in accordance with claim 59, additionally comprising the step of
following user review and validation or completion or correction of a request, analyzing any changes made by the user to validate any new rules developed through fuzzy logic techniques and adding them to the dictionary database, and to give positive or negative feedback to the fuzzy logic system in accordance with its performance.

61. A method in accordance with claim 60, additionally comprising the step of
validating the source of the request.

62. a method in accordance with claim 61, additionally comprising the step of
validating the user's identification.

63. A method in accordance with claim 56, additionally comprising the steps of
establishing a dictionary database containing rules associating non-personal identifiers with specific data fields within requests; and
attempting to complete such requests using the personal information through the use of rules obtained from the dictionary database applied using fuzzy logic techniques.

64. A method in accordance with claim 63, additionally comprising the step of
following user review and validation or completion or correction of a request, analyzing any changes made by the user to validate any new rules developed through fuzzy logic techniques and adding them to the dictionary database, and to give positive or negative feedback to the fuzzy logic system in accordance with its performance.

65. A method in accordance with claim 64, additionally comprising the step of
validating the source of the request.

66. a method in accordance with claim 65, additionally comprising the step of
validating the user's identification.

67. A system for automatically complying with requests for information received from a network and directed to a user's browser, comprising:
a data flow monitor interposed between the network and the user's browser that intercepts such requests;
a validation program coupled to the data flow monitor that determines and validates the user's identification and that validates the source of the request;
a wallet database where personal information of one or more users is kept in a secure manner and is associated with non-personal identifiers;
a dictionary database containing rules governing what information, identified by non-personal identifiers, goes where in particular types of requests;
a history database containing at least some previously-completed and user-validated requests in which at least some personal information is replaced by the non-personal identifiers to at least partly depersonalize the requests;
a request completion system coupled directly or indirectly to the above elements that accepts such requests, that attempts to fulfill such requests using information obtained from the wallet database through the use of rules obtained from the dictionary database specifically applicable to that particular type of request, through the use of other rules obtained from the dictionary database applied using fuzzy logic techniques, through the use of history database records of one or more previously completed, validated copies of the same type of request, and through asking the user to complete all or those portions of a request not automatically completed and to validate all or those portions of a request automatically completed;
said request completion system further including a completed request analysis engine that validates new sets of rules developed through fuzzy logic analysis of existing rules or through history database request analysis and through user validation with respect to a particular type of request, that gives positive or negative training feedback to the fuzzy logic system in accordance with its performance as accepted or corrected by users, and that can add completed, user verified, and at least partly depersonalized requests to the history database.

68. A method for automatically complying with requests for information received from a network and directed to a user comprising the steps of:
establishing a wallet database where user information can be kept secure and can be associated with non-personal identifiers;
establishing a history database where at least some previously-completed and user-validated requests may be kept with at least some personal information replaced by non-personal identifiers to at least partly depersonalize the requests;
establishing a dictionary database containing rules associating non-personal identifiers with specific data fields within specific types of requests;
monitoring the flow of all data flowing between the network and the user and intercepting such requests for information;
validating the user's identification, and validating the source of the request;
attempting to complete such requests using information obtained from the wallet database through the use of rules obtained from the dictionary database specifically applicable to a particular type of request, through the use of rules obtained from the dictionary database applied using fuzzy logic techniques, through the analysis of history database records of one or more completed, validated copies of the same type of request, and through asking the user to complete all or those portions of a request not automatically completed and to validate all or those portions of a request automatically completed; and
following user review and validation or completion or correction of a completed request, analyzing any changes made by the user to validate any new rules developed through fuzzy logic or history database analysis techniques and adding them to the dictionary database, also to give positive or negative feedback to the fuzzy logic system in accordance with its performance, and also to add completed, user verified, and depersonalized requests to the history database.

69. A system for completing forms requesting personal information received from a network and directed to a user, said system comprising:
a data flow monitor interposed between the network and the user that intercepts such forms;
a history database containing at least some previously-completed forms;
a form fill system coupled directly or indirectly to the above elements that accepts such forms, that attempts to complete such forms using personal information through the use of history database records of one or more previously completed copies of the same form and also through asking the user to complete at least portions of forms not automatically completed;
said data flow monitor intercepting what the user fills in and sending it to the form fill system which writes it to the history database.

70. A system in accordance with claim 69 to which is added
a dictionary database containing field names associated with certain form components that are used to populate the forms;
and wherein the request completion system also attempts to complete such through the use of field names found in the dictionary database that match field names in the form.

71. A system in accordance with claim 70
wherein the form fill system extracts rules from previously completed forms in the history database, thereby developing from the history database rules for filling in forms.

72. A system in accordance with claim 71
wherein the form fill system also attempts to fill in forms using personal information through the use of information in the dictionary database and fuzzy logic techniques.

73. A system in accordance with claim 72 to which is added
a dictionary database containing field names associated with certain form components that are used to populate the forms;
and wherein the form fill system also attempts to complete such forms through the use of field names found in the dictionary database applied using fuzzy logic techniques.

74. A system in accordance with claim 73
wherein the form fill system extracts rules from previously completed forms in the history database, thereby developing from the history database rules for filling in forms.

75. A method for automatically filling in forms received from a network and directed to a user with personal information, comprising the steps of:
establishing a history database where at least some previously completed forms may be kept;
monitoring the flow of data between the network and the user and intercepting such forms requesting information;
attempting to complete such forms with personal information through the use of history database records of one or more completed copies of the same form, and through asking the user to complete at least some portions of forms not automatically completed;
and intercepting what the user fills in and writing it to the history data base for future use.

76. A method in accordance with claim 75 additionally comprising the steps of
establishing a dictionary incorporating a series of names associated with certain form components that may be used to populate forms; and
attempting to complete such forms with personal information through the use the dictionary information applicable to a particular form.

77. A method in accordance with claim 76, additionally comprising the step of
intercepting what the user fills in to a form and adding it to the history database for future use.

78. A method in accordance with claim 77, additionally comprising the step of
attempting to fill in forms with personal information through the use fuzzy logic techniques applied to information obtained from the dictionary.

79. A method in accordance with claim 75, additionally comprising the steps of
establishing a dictionary incorporating a series of names associated with certain form components that may be used to populate forms; and
attempting to complete forms with personal information through the use of information obtained from the dictionary applied using fuzzy logic techniques.

80. A method in accordance with claim 79, additionally comprising the step of intercepting what the user fills in and adding it to the history database for future use.
